(19) United States
(12) Patent Application Publication
(10) Pub. No.: US 2013/0318424 A1
(43) Pub. Date: Nov. 28, 2013

(54) SYSTEM AND METHOD FOR THE CREATION OF AN E-ENHANCED MULTI-DIMENSIONAL PICTOSTORY USING PICTOOVERLAY TECHNOLOGY

(71) Applicant: Ian A. R. Boyd, North Las Vegas, NV (US)

(72) Inventor: Ian A. R. Boyd, North Las Vegas, NV (US)

(21) Appl. No.: 13/829,196

(22) Filed: Mar. 14, 2013

Related U.S. Application Data
(60) Provisional application No. 61/652,306, filed on May 28, 2012.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.

(51) Int. Cl. G06F 17/21

(52) U.S. Cl. CPC G06F 17/212
USPC 715/202

(57) ABSTRACT

A software application program on a computer platform transforms a structured basic idea into a pictorial interpretation in the form of an E-Enhanced Multi-Dimensional PictoStory Presentation using PictoOverlay Technology that presents the basic idea in a format, like a film, where the basic idea is transformed into a series of moving pictures with special effects and enhancements, both audio and visual, that end up making the basic idea come alive visually, emotively and evocatively. More specifically, the software application program combines and layers static images and displays them dynamically and sequentially, adding audio and video enhancements to create a presentation like a film. The software program further transforms the basic idea into an infinitely variable array of pictorial elements and enhancements that extend the basic idea to intrigue, entertain, educate, and have users interact with the basic idea.

### CROSS REFERENCE TO RELATED APPLICATIONS

This application claims the benefit of U.S. Provisional Application No. 61/652,306 filed May 28, 2012 entitled AUDIO VIDEO FILM CREATOR FROM STORYLINE, CAST AND CONTEXT SETTINGS INPUT, U.S. Provisional Application No. 61/705,686 filed Sep. 26, 2012 entitled SYSTEM AND METHOD FOR THE CREATION OF ENHANCED AUDIO VISUAL STORYBOARDS USING A LAYERED COMPOSITE IMAGE GENERATOR, U.S. Provisional Application No. 61/716,508 filed Oct. 20, 2012 entitled SYSTEM AND METHOD FOR THE CREATION OF AN ENHANCED MULTI-DIMENSIONAL PICTOGAME, U.S. Provisional Application No. 61/750,022 filed Jan. 8, 2013 entitled SYSTEM AND METHOD FOR THE CREATION OF AN E-ENHANCED MULTI-DIMENSIONAL PICTOKIDS PRESENTATION and U.S. Provisional Application No. 61/763,749 filed Feb. 12, 2013 PAYMENT AND ACCOUNT MANAGEMENT SYSTEM USING PICTOOVERLAY TECHNOLOGY which are hereby incorporated herein by reference in their entireties.

### FIELD OF INVENTION

The present invention relates to a software application system and method for creating an enhanced featured, displayable, narrated, musicked, Multi-Dimensional PictoStory Presentation using Pictooverlay Technology and a PictoOverlay Interface to dynamically present an artistic, informative, educational, factual, story, game-puzzle or other Basic Idea in an evocative and emotive format. The software application transforms and structures a Basic Idea into a set, series or Sequence of ordered Elements. An arranged criteria, referred to herein as KeyConcepts is then applied to the Sequence of Elements to gather information on the Basic Idea. By applying the KeyConcepts, the Basic Idea is transformed to a set of expanded Textual Outlines from each of the Sequence Elements and a Summary outline of all Elements is created. The Textual Outlines are used to populate a transparent page map using a Blueprint Generator having Production Control System Tools that are used to create and pictorially present, edit, modify, enhance, navigate, and transform the Basic Idea and its Components and Sub-Components into a Multi-Dimensional PictoStory Presentation.

In creating the Multi-Dimensional PictoStory Presentation, a series of Composite Images representing each Textual Outline are created and placed within the Referenced Page Map of an Architectural Blueprint to statically ‘Page Present’ the Basic Idea, its Composite Images and their components/sub-components in a page-driven pictorial format. The Blueprint and its Composite Images are then extended and enhanced using audio, narration, animation, video, video effects, sound effects, slide shows, image Components, etc. or any variation of Enhancements or effects to transform the Basic Idea into a dynamic E-Enhanced Multi-Dimensional PictoStory Presentation. Using a categorized Data Store Resource and the Production Control features of the Blueprint Generator a plurality of alternative Components and Enhancements are available to modify any Component or Sub-Component of the E-Enhanced Multi-Dimensional PictoStory Presentation that is based upon the KeyConcepts such as characters, locations, temporal settings, narration, musical genre or any other feature to expand and extend the initial Basic Idea.

### BACKGROUND OF THE INVENTION

The most sophisticated complete way to tell a story or describe a concept or idea is to fully render it in the form for which it was intended, for example as a film, a book, a play, a game-puzzle, etc. The development and execution of this creative process in writing, performing, filming, editing and presenting may involve numerous hours, many people, and a significant cost. A barrier to this type of development often is the initial funding to incorporate the resources necessary to form and advance this process. While basic methods to describe a Basic Idea exist, they vary from a Textual Outline, to a treatment, a slideshow, a demonstration, or a presentation with each a more sophisticated media for communicating an idea. Digital means to present the outline, plot or overview of the Basic Idea are for example, MS PowerPoint or other presentation software, Adobe Photo Shop or other image editing software, and/or audio recorders-mixers for sound reproduction, or video recording and film editing software. Not available however is software that expands a Basic Idea into a presentable multi-functional, Multi-Dimensional film-like narrated, musicked format (with all its components pictorially page-presented sequentially in a page-driven Blueprint) and into a structured form that has significantly more content than its original outline with instantly changeable variable Components without a significant financial investment. Importantly, to achieve any of these in any detail requires more or less specific input from the creator where the result is invariably one-off, final and finite.

A possible distant comparison of this form of software is, for example, a Business Plan Template where the creator expands the outline with dedicated input. Other such application software deals with editing of a film, book, play, song or other media format for example. Other software exists to create a composite multi-layered image(s) that may be rendered as audio/visual slideshows. What is not known in the prior art is a software platform that accepts a Basic Idea and transforms the idea in a structured format in the form of a ‘Variable Architectural Blueprint’ which in turn pictorially presents (page-like) provides for the variable expression of that idea and each expanded element of that idea in numerous self-contained or interdependent media formats to enhance, expand and dynamically and emotionally present the idea.

### BRIEF SUMMARY OF THE INVENTION

The software application system and method of the present invention provides an accessible format to transform an artistic, informative, educational, factual, story, game, puzzle or other Basic Idea into an enhanced featured, displayable narrated, musicked, audio, video presentation to communicate the idea in an active dynamic, evocative and emotive format. Using this software application referred to herein as E-Enhanced Multi-Dimensional PictoStory Software Application, a Basic Idea is transformed into a static pictorial representation, enhanced incorporating audio, video, slide, animation, interactive features, effects and other media, and expanded upon by effortlessly modifying characters, features, scenarios, actions and outcomes to effectively communicate the Basic Idea to inform, educate, entertain and possibly assist in procuring requisite funding to formalize the Basic Idea into a film, book, play, song or other media format.

The E-Enhanced Multi-Dimensional PictoStory Software Modules

Using the E-Enhanced Multi-Dimensional PictoStory Software, a Basic Idea that may for example be an engineering concept, educational instruction, an historic event, a musical piece, a short story, a novel, a game, a puzzle, or an in depth and detailed full-length feature film script is extended and expanded using three Application Modules to create, develop, interact with and present an E-Enhanced Multi-Dimensional PictoStory Presentation. Multi-Dimensional refers to the expansion of the Basic Idea into a series of dimensions to extend, elaborate and transform the Basic Idea. A first dimension, as an example in this context, may simply be the written word describing the Basic Idea. A second dimension may be a static two-dimensional pictorial image representing the Basic Idea. A third dimension may be a layered or Composite Image 3-dimensional image formed from a number of layered pictorial images of the Basic Idea. A fourth dimension is the addition of time structure to the layered Composite Images by creating a sequence or time relationship of the Basic Idea with events, actions and outcomes. A fifth dimension is an infinitely variable set of Enhancements that provide action, movement and depth to the Basic Idea. In point of fact, Enhancements may be seen as extending the Basic Idea beyond the four normally used dimensions, and into many-dimensions to intrigue, entice and evoke an emotional or captivating response from a viewer of the E-Enhanced Multi-Dimensional PictoStory Presentation.

### Module A: Storyline Generator

The Storyline Generator of Module A of the E-Enhanced Multi-Dimensional PictoStory Software Application structurally divides the Basic Idea into one or more parts formatting the Basic Idea into a set, a series or a Sequence of Elements. A KeyConcepts Multiple Query is applied to each of the Sequence of Elements and to a Summary of the Basic Idea. The Multiple Query presents a series of questions in a responsive format and the answers to each question are transformed into a set of expanded Textual Outlines with a separate outline for each of the Sequence Elements and the Summary. For example, the Basic Idea may be XMAS, the Sequence Elements may be structured into for example a series of five Elements that each have the KeyConcepts Multiple Query applied to acquire responses to a general set of questions. The most basic questions of Who?, What?, Where?, When?, Why?, How?, Wow Factor? and What happens next? may be included within each Sequence Element Query and within a Summary of all Elements to extend the initial Basic Idea. These general questions are referred to in short format herein as 6W COOL questions that may commonly be used to extend a Basic Idea, although varied subject matter may require distinctly different queries to properly extend and transform the Basic Idea and these as well are within the purview of the present invention. In our example of XMAS, the answers to the questions may include events such as cutting down a XMAS tree, sitting by a cozy fire, opening presents under the tree based on the responses to the 6W COOL questions of Who is opening presents? What is the weather like outside to make a fire so cozy? Where is the XMAS tree being cut down? This information gathered from the KeyConcepts Multiple Query is transformed into an expanded or amplified Textual Outline. Using the Blueprint Generator, these Textual Outlines are used to page-populate a blank Architectural Blueprint that includes a Page Mapped display view for all Components and Sub-Components, and the entire formatted structure for the Page Maps, Referenced Cell Maps, File Folders and File Names.

### Module B: The PictoStory Blueprint and Blueprint Generator

The blank Architectural Blueprint is formatted to match the number of Textual Outlines and Basic Idea Summary. In a first example, the Basic Idea is structurally divided into a Series of Five Elements and a Summary and therefore the Architectural Blueprint is formatted with structured page locations for Five Elements and a Summary. This is expanded into Page Displays for Components and Sub-Components that are pictorially represented as a navigable sequenced page driven Display PictoStory Wall of pages in a matrix format within the generated Blueprint. The Five Textual Outlines for each of the Five Elements and the Summary are located as columnar ‘Page Displays’ within the PictoStory Blueprint. In this top down approach, the Basic Idea has been transformed to an expanded textual description and has been initially populated with only this set of textual descriptions of the Basic Idea. A bottom up approach is then applied to create a set of pages of pictorial representations of the Five Elements, their Components and Sub-Components. A first step is to categorize a functional group of Raw Images related to the Basic Idea based upon the responses to the KeyConcepts Multiple Query using a Data Store Generator. In this categorization, images relating to the Who, the What, the Why, etc. are grouped within structured file folders. A single group of Raw Images representing one of the KeyConcepts is displayable as a matrix or Montage of images, for example for a What response, rows and columns of images of XMAS trees may be displayed to represent this KeyConcepts of the Basic Idea pictorially.

Raw Images from these Montages are then selected, using the PictoLayer Generator and stylized by shaping, cropping, and sizing the Raw Images. The Pictolayer Generator then removes the white background from the shaped, cropped, and sized Pictorial Element by positioning the element within a blank transparent page to form a Trans-Snip. The blank transparent provides a Resolution Cell Map that indicates a position of the Pictorial Element within the Trans-Snip with for example, a furthest left, upper portion of the Pictorial Element being the coordinate location on this pixel level cell map. A Trans-Snip Layer Page showing each process step from the Raw Image stylized Trans-Snip is created. Enhancements may be associated with the Trans-Snip Layer at this level as described herein.

The Trans-Snip Layers are aligned using a PictoComposite Generator, to form a Composite Image that is located within a Referenced Page Cell Map or grid coordinate system of the page display. A series of Trans-Snip Layers that correspond to the KeyConcepts applied to the Sequence of Elements are used to create six Composite Images corresponding to the five Textual Outlines and the Basic Idea Summary Outline. For example, a Composite Image may be formed from a series of eight Trans-Snip Layers with each layer corresponding to the responses within the Textual Outline for the 6W COOL questions of 1. Who?, 2. What?, 3. Where?, 4. When?, 5. Why?, 6. How?, 7. Wow! What happens? and 8. Enhancement. A Composite Image Page is formed that includes the Composite Image, each Trans-Snip Layer and the corresponding KeyConcepts Multiple Query that the Trans-Snip Layer represents. The Composite Image Pages are then located within pre-defined locations on the blank, formatted Architectural Blueprint with each Composite Image Page located with each of the five Textual Outlines and Textual Outline Summary forming a PictoStory Storyboard. The Basic Idea may be structured with any number of Sequence Elements and Textual Outlines and with any number of Composite Images associated with each Outline with the number being defined by the complexity of the Basic Idea.

The formation of an Architectural Blueprint that is populated from the Basic Idea both textually and pictorially is referred to herein as a PictoStory Blueprint and is used as the work surface as a Display Wall of Pages to develop, expand and enhance the PictoStory Storyboard. Every Component and Sub-Component that includes Composite Images, Trans-Snips, Raw Images and Enhancements and others are available through a Referenced Page Map or PictoStory Wall that provides access to arrange, edit and present of the PictoStory using Production Control Tools of the Blueprint Generator.

The Blueprint Generator Production Control Tools are used to create, arrange, modify, enhance, edit and present the PictoStory in a significantly expanded ‘Infinitely Variable’ E-Enhanced Multi-Dimensional PictoStory Presentation. The pictorial and textual representation is expanded by associating one or more Enhancements at each dimensional level of the PictoStory. Enhancements provide contextual details to amplify and assist in the presentation of the action and content of a structural Component and extend the Sequence of Elements and Composite Images by modifying Components or Sub-Components of the KeyConcepts such as, through enhancing the characters, settings, actions or events of the Basic Idea with no limit—except the imagination—as to what an enhancement might actually be and therefore is infinite in possible information that may be presented to expand the Basic Idea.

Using an Enhancements Generator, the PictoStory may be dynamically transformed where Enhancements referenced by a Page Cell Map may be associated with each Trans-Snip or with a Composite Image or a set of Composite Images with the dynamic transformation adding one or more varied media formats, such as, Text, Narration Text, Narration Record, Song, Music, Sound Effects, Video, Video Effects, Animation, or any other supportive Element. The enhancement may also be in the form of a hyperlink, Subroutine or other script that links a designated access point within the Resolution Cell Map of the Trans-Snip or the Referenced Cell Map of the Composite Image to activate and/or run the additional information about the KeyConcepts of the Basic Idea. Referring to the XMAS example, a layered Composite Image may be made up of a wintry forest scene, an axe, a beautiful pine tree, an old man and a boy, and other Trans-Snips that visually present the Basic Idea of chopping down a tree for XMAS. The sound of the axe chopping, a horse drawn sleigh in the distance moving through the snow, the sound of people singing may all be Enhancements that dynamically expand and extend the Basic Idea.

The linked Enhancements are stored within the secure, Data Store Resource using a specific file folder structure based upon the Referenced Page Cell Map where a Component, Sub-Component or Enhancement is stored with a randomized, scrambled and/or encrypted file name that corresponds to a coordinate of the Referenced Page Cell Map that provides for Activation of any Component by accessing any or all referenced coordinates within the Cell Map. Importantly, while the content of each file is based on the KeyConcepts of the Basic Idea, for example the responses to the 6W COOL questions of Who?, What?, Where?, When?, Why?, How?, and Wow What happens?, the filename is not in any way associated with the content of the file but instead is specifically associated with the randomized, scrambled, encrypted Cell Map Coordinate.

This unique file structure also provides for Alternative Components that meet similar criterion of a KeyConcepts to be selected and interchanged within the PictoStory Presentation by using a matching randomized, scrambled or encrypted coordinate filename. The Alternative Component may be a different character, a new setting, or a different event, action and/or outcome that may be viewed in a temporary folder and then if chosen be seamlessly replaced within the PictoStory by transferring the Alternative Component to an active folder and thereby overwriting the currently Active Component. The flexibility to effortlessly change any component within the PictoStory provides infinitely variable storylines, characters and outcomes creating a truly Multi-Dimensional presentation.

### Module C: The PictoStory Presenters

The Architectural Blueprint derived from the Blueprint Generator has navigation tools that access three separate coordinate systems; the Page Map, Referenced Cell Map on a Page and Resolution Cell Map coordinate used mainly for Pictorial Element or Snip positions whereby all three types of reference locations may provide access to each Multi-Dimensional layer of the Components and Sub-Components or Enhancements of the PictoStory. Other control system features of the Blueprint Generator allow a user to order, modify, enhance, edit, playback, review, combine, render and activate the PictoStory Storyboard to construct a film-like, Enhanced Multi-Dimensional PictoStory Presentation of the Basic Idea. The Architectural or PictoStory Blueprint provides a page-pictorial working surface to facilitate the creation and editing of the presentation by replacing one or more Components or Sub-Components and by providing for the addition of audio or visual effects, narration, background music or other features. Using these control features, the static pictorial representation of the PictoStory is transformed from a static to a dynamic state to present an Enhanced Multi-Dimensional PictoStory film-like presentation.

In this transformation from a static to a dynamic state described as rendering and realization three levels of access referred to herein as E in the E-Enhanced Multi-Dimensional PictoStory Software Application determine the level of access to the content and editing tools of the PictoStory.

The first level of access, Activation, provides complete access to view all content within the PictoStory to control, arrange, change, modify, replace and edit the content of all Components, Sub-Components and Enhancements. The Control System Tools further provide the ability to amplify all or any portion of the content such as to activate a single enhancement associated with a Composite Image or to activate a portion of the Multi-Dimensional PictoStory Presentation using any number of enhanced Composite Images.

A second level of access, WebliZation, provides internal, client-based access to view all or portions of the E-Enhanced Multi-Dimensional Presentation and to select Alternative Components, Sub-Components and Enhancements and view these changes within a temporary file structure to determine final data content, the application software providing an interactive creative process to develop and edit the PictoStory. Other features such as the selection of Enhancements for the PictoStory may be accessible at this level of access, however importantly, no permanent changes may be made to the PictoStory at this level.

The third level, WebliCation, provides web based access through a secure website format to view, note, suggest view potential modifications, test, etc. the E-Enhanced Multi-Dimensional PictoStory Presentation in a near final form. Options to select Alternative Components associated with the KeyConcepts, are available again providing interaction to the viewer to review dictate the characters, settings, events and outcomes of the PictoStory. Permanent modifications to the PictoStory at this level are prevented. The access levels, provide different levels of users a range of control tools to interact with, modify and expand the E-Enhanced Multi-Dimensional PictoStory Presentation providing a platform to use the application software in a variety of applications.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the Components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the invention is to provide a software platform on a computer system that transforms a Basic Idea into a Structured Multi-Dimensional PictoStory defined as an enhanced featured, dimensionally layered, displayable, narrated, musicked, audio/video representation of the Basic Idea in a dynamic, evocative and emotive pictorial presentation.

Another object of the invention is the structuring of a Basic Idea into a set, series or sequence of elements and applying KeyConcepts as a responsive query to create an expanded Textual Outline of the Basic Idea using a Storyline Generator.

Another object of the invention is the creation of a formatted multi page-driven display or Architectural Blueprint based upon the structured sequence of elements and application of the KeyConcepts of the Basic Idea using a Blueprint Generator and locating the expanded Textual Outlines within the Architectural Blueprint, to be able to visually sequentially follow or navigate the elements (or expanded elements) and their Components and Sub-Components.

Another object of the invention is the categorization of a Data Store Resource and displaying a functional group of Raw Images in a Montage based upon the KeyConcepts Multiple Query responses.

Another object of the invention is to acquire and process of one or more Raw Images from the Montage using a PictoLayer Generator by shaping, cropping from any portion of the Raw Image, and sizing to form a Pictorial Layer which is related to the KeyConcepts of the Basic Idea, becoming a part layer of the Composite Image.

Another object of the invention is to locate a Raw Image or portion of the Raw Image or Pictorial Element on a transparent blank having Resolution Cell Map thereby removing the white background to form a transparent cropped, shaped, sized Trans-Snip.

Another object of the invention is to layer the Trans-Snips to form a layered Composite Image and associate the Composite Image with a Referenced Cell Map using the PictoComposite Generator.

Another object of the invention is to locate the layered Composite Images with the expanded Textual Outline within the Architectural Blueprint to form a PictoStory Storyboard.

Another object of the invention is to integrate audio, video, text, pictorial and non-pictorial Enhancements to a Trans-Snip, a layered Composite Image, a group of layered Composite Images, or to a PictoStory to provide additional Multi-Dimensional information about the KeyConcepts of the Basic Idea forming an Enhanced Multi-Dimensional PictoStory.

Another object of the invention is using control system tools of the Blueprint Generator to create, navigate, order, modify, enhance, edit, playback, review, combine, render, realize and activate to produce an E-Enhanced Multi-Dimensional PictoStory.

Another object of the E-Enhanced Multi-Dimensional PictoStory Application Software is the structured series of file folders within the secure, KeyConcepts based Data Store Resource to store Raw Images, Pictorial Elements, Trans-Snips, and Enhancements with randomized, scrambled or encrypted file names based on the Structured Page Map of the formatted Architectural Blueprint to index and categorize data within the file folder structures based upon the responses to the KeyConcepts Multiple Query of the Basic Idea.

Another object of the invention is the seamless replacement of any Raw Image, Pictorial Element, Trans-Snip, Composite Image, Enhancement, PictoStory and/or Component or Sub-Component of a PictoStory by selecting an Alternative KeyConcepts Component from a Montage of categorized and indexed Alternative Components and renaming the Alternative Component to match the randomized, scrambled and/or encrypted file name of the Structured Page Map of the Architectural Blueprint for the Interchangeable Component.

A still further object of the invention is secure multi-level access to the features of the E-Enhanced Multi-Dimensional PictoStory Application Software using for example, Activation, WebliZation and WebliCation to construct, view and modify a film-like, Multi-Dimensional PictoStory Presentation of the Basic Idea.

A further object of the E-Enhanced Multi-Dimensional PictoStory Application Software is the transformation of the expanded Textual Outline of a Basic Idea into a dynamic, enhanced, overlaid visually ‘Show not Tell’ representation of the KeyConcepts to inform, educate, entertain, interact with and to assist in procuring requisite funding to formalize the Basic Idea into a film, kids story, picto-puzzle, picto-game, book, play, song or other media format.

The present invention relates to a pictorial representation software system for the creation of an enhanced multi-dimensional pictostory presentation, comprising application software installed on a computer system, the application software further comprising, a storyline generator, a pictolayer generator, a pictocomposite generator, an enhancements generator, a blueprint generator, and wherein a textual data file is transformed into an expanded textual outline by the storyline generator, a plurality of trans-snips representing the expanded textual outline are created by the pictolayer generator, the plurality of trans-snips are layered to form at least one composite image by the pictocomposite generator, the textual outlines, plurality of trans-snips and at least one composite image are located within an architectural blueprint formatted by the blueprint generator to form at least one pictostory, at least one enhancement is associated to one of at least one trans-snip from the plurality of trans-snips, at least one composite image and at least one pictostory within the architectural blueprint using the enhancements generator; and at least one pictostory is rendered to create an enhanced multi-dimensional pictostory presentation. In the pictorial representation software system for the creation of an enhanced multi-dimensional pictostory presentation, the storyline generator structures the textual data file into a plurality of elements and at least one summary and applies a query of key concepts in a responsive format to the plurality of elements and at least one summary to create the expanded textual outline.

Further in the pictorial representation software system at least one trans-snip from the plurality of trans-snips is formed from a raw image by shaping, cropping and sizing the raw image that is stored within a data store resource. The trans-snip is formed from the raw image by removing a white background and locating the at least one trans-snip on a transparent blank. The architectural blueprint of the pictorial representation software system further includes a plurality of blank transparent sheets, each sheet having a page map coordinate system for locating at least one trans-snip from the plurality of trans-snips, at least one composite image and at least one enhancement. This page map coordinate system of the architectural blueprint further structures at least one alternative trans-snip, at least one alternative composite image, and at least one alternative enhancement within the data store resource for replacement within the enhanced multi-dimensional pictostory presentation. At least one composite image of the pictorial representation software system further includes a cell map coordinate system and at least one enhancement may be associated with a location on the cell map. At least one trans-snip from the plurality of trans-snips from the pictorial representation software system further includes a resolution map coordinate system and at least one enhancement is associated with a location on the resolution map. At least one enhancement from the pictorial representation software system is selected from at least one of audio files, recorded narration, animation, video files, video effects, sound effects, slide shows, and image components and access to the pictorial representation software system and the enhanced multi-dimensional pictostory presentation is restricted.

The present invention further relates to a method of representing a textual data file of a basic idea pictorially, comprising the steps of accessing application software installed on a computer system, entering a textual data file of a basic idea into the application software, transforming the textual data file of the basic idea into an expanded textual outline, creating a plurality of trans-snips related to the expanded textual outline, layering the plurality of trans-snips to form at least one composite image, populating a pictostory blueprint with the textual outlines, the plurality of trans-snips and the at least one composite image to create at least one pictostory, associating at least one enhancement with one of at least one trans-snip from the plurality of trans-snips, at least one composite image and at least one pictostory, rendering at least one of the plurality of trans-snips, at least one composite image, at least one pictostory and at least one enhancement to create a pictorial presentation of the basic idea. The method of representing a textual data file of a basic idea pictorially further comprises the steps of structuring the textual data file of the basic idea into a plurality of elements and at least one summary and applying key concepts to the plurality of elements and at least one summary. The method of representing a textual data file of a basic idea pictorially also further comprises the step of forming a transparent blank within the pictostory blueprint having a page map coordinate system for locating at least one trans-snip from the plurality of trans-snips, at least one composite image, at least one pictostory and at least one enhancement within the page map.

The method of representing a textual data file of a basic idea pictorially also comprises the step of replacing one of at least one trans-snip from the plurality of trans-snips, at least one composite image and at least one enhancement with one of at least an alternative trans-snip, an alternative composite image and an alternative enhancement. The method of representing a textual data file of a basic idea pictorially also comprises the steps of associating a cell map coordinate system with at least one composite image and associating at least one enhancement with a location on the cell map and associating a resolution map coordinate system with at least one trans-snip from the plurality of trans-snips and associating at least one enhancement with a location on the resolution map.

The method of representing a textual data file of a basic idea pictorially, further comprises the steps of creating at least one trans-snip from the plurality of trans-snips from a raw image retrieved from a data store resource by shaping, cropping and sizing the raw image and by removing a white background and locating the at least one trans-snip from the plurality of trans-snips on a transparent blank. The method of representing a textual data file of a basic idea pictorially also includes the step of selecting at least one enhancement from at least one of audio files, recorded narration, animation, video files, video effects, sound effects, slide shows, and image components.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating the Modules A, B, and C that in a first embodiment make up the E-Enhanced Multi-Dimensional PictoStory Application Software of the present invention.

FIG. 2 is a block diagram of a first embodiment of the computer platform of the E-Enhanced Multi-Dimensional PictoStory Application Software of the present invention.

FIG. 3 is a block diagram representation of the components of the Storyline Generator and the generated enhanced Textual Outlines of a first embodiment of the present invention.

FIGS. 4A and 4B are illustrative representation of a Referenced Page Map and Page Cell Map of a first embodiment of the present invention.

FIG. 5 is illustrative representation of an Architectural Blueprint Transparent Formatted Page Cell Map of a first embodiment of the present invention.

FIG. 6 is a diagrammatic representation of the operation of the Storyline Generator of a first embodiment of the present invention.

FIGS. 7A-7C are illustrative representations of Pictorial Elements of a first embodiment of the present invention.

FIG. 8 is an illustrative representation of a Montage of Raw Images from a Data Store Resource of a first embodiment of the present invention.

FIGS. 9A and 9B are an illustrative representation of a Blank Resolution Cell Map of a first embodiment of the present invention.

FIGS. 10A-10D are diagrammatic representations of the operation of the PictoLayer Generator in selecting a Pictorial Element from a Raw Image of a first embodiment of the present invention.

FIG. 11 is an illustrative representation of a Trans-Snip Layer Page of a first embodiment of the present invention.

FIGS. 12A-12D are diagrammatic representations of the operation of the PictoLayer Generator in selecting a portion of the Pictorial Element selected in FIGS. 9A-9D from a Raw Image in a first embodiment of the present invention.

FIGS. 13A and 13B are diagrammatic representations of Trans-Snips located on separate Transparent Resolution Cell Maps in a first embodiment of the present invention.

FIG. 14 is a diagrammatic representation of a partial overlay of the Trans-Snips of FIGS. 12A and 12B in a first embodiment of the present invention.

FIG. 15 is a diagrammatic representation of a complete overlay of the Trans-Snips of FIGS. 12A and 12B in a first embodiment of the present invention.

FIG. 16 is a diagrammatic representation of a composite Trans-Snip Layer having a first and second Pictorial Element in a first embodiment of the present invention.

FIG. 17 is a diagrammatic representation of a partial overlay of the composite Trans-Snip Layer of FIG. 16 with a second and third Trans-Snip Layer.

FIG. 18A is a diagrammatic representation of a layered Composite Image of the composite Trans-Snip Layer of FIG. 16 with the second and third Trans-Snip Layers.

FIG. 18B is a diagrammatic representation of layered Composite Image of the composite Trans-Snip Layer of FIG. 16 with multiple Trans-Snip Layers.

FIG. 19 is an illustrative representation of a layered Composite Image Page of a first embodiment of the present invention.

FIG. 20A is a diagrammatic representation of a partial overlay of a Pictorial Element of a first Trans-Snip over a second Pictorial Element of a second Trans-Snip.

FIG. 20B is a diagrammatic representation of the activated Pictorial Element of a first layer Trans-Snip with access point coordinates for activating enhancements.

FIG. 20C is a diagrammatic representation of an embodiment of the Resolution Cell Map of an activated Pictorial Element of a first layer Trans-Snip of the present invention.

FIG. 21 is a diagrammatic representation of a first embodiment of a populated PictoStory StoryBoard of the present invention.

FIG. 22 is a diagrammatic representation of a Referenced Page Map of the present invention.

FIG. 23 is a diagrammatic representation of a Referenced Page Map with a PictoStory StoryBoard of the present invention.

FIG. 24 is a diagrammatic representation of a Referenced Page Map with a Composite Image Page and Trans-Snip Page of the present invention.

FIG. 25 is a diagrammatic representation of a further embodiment of a Referenced Page Map with a Montage of the Data Store Resource of the present invention.

FIG. 26 is a diagrammatic representation of a first embodiment of a Control Panel for the Blueprint Generator Production Controls of the present invention.

FIG. 27 is a diagrammatic representation of a further embodiment of a Composite Image Page of the present invention.

FIG. 28 is a diagrammatic representation of a further embodiment of a Data Store Resources Montage Page for the KeyConcepts Who of the present invention.

FIG. 29 is a diagrammatic representation of a first embodiment of an interchangeable KeyConcepts Who component within a Composite Image Page of the present invention.

FIG. 30 is a diagrammatic representation of a first embodiment of an interchangeable KeyConcepts Where component within a Composite Image Page of the present invention.

FIG. 31 is a diagrammatic representation of the Composite Image Page with Interchangeable KeyConcepts Components for Who and Where replaced in a further embodiment of the present invention.

FIG. 32 is a diagrammatic representation of a first embodiment of levels of access and control of a Multi-Dimensional PictoStory Presentation within the E-Enhanced Multi-Dimensional PictoStory Software Application.

FIG. 33 is a block diagram of the elements of Modules A, B and C of a first embodiment of the present invention.

### DETAILED DESCRIPTION OF THE INVENTION

Turning now descriptively to the drawings, in which similar reference characters denote similar elements throughout the several views, the figures illustrate the E-Enhanced Multi-Dimensional PictoStory Application Software transforms a structured Basic Idea which may be for example, an engineering concept, educational instruction, an historic event, a musical piece, a short story, or an in depth and detailed full-length feature film script into an infinitely variable E-Enhanced Multi-Dimensional PictoStory Presentation.

Details of the E-Enhanced Multi-Dimensional PictoStory Software Modules

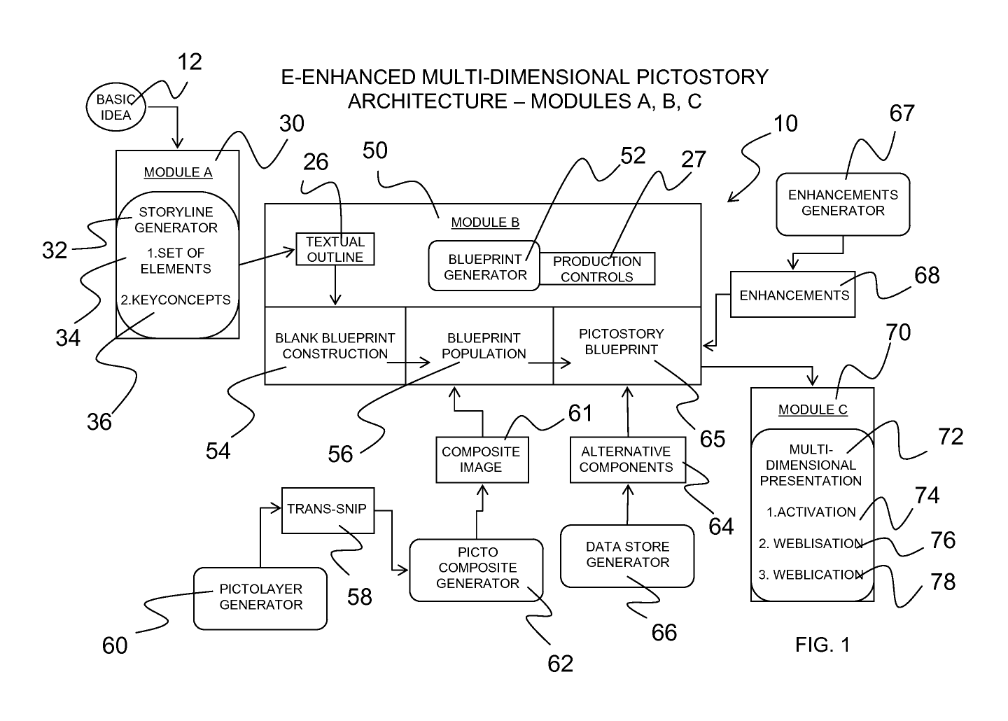

In a first embodiment as shown in FIG. 1, the E-Enhanced Multi-Dimensional PictoStory Application Software system indicated diagrammatically as 10, comprises three modules that include a Storyline Generator 32 in Module A 30, a Blueprint Generator 52 in Module B 50, and PictoStory Presenters in Module C 70, Within these modules, software application tools on a computer platform 5 transform a Basic Idea 12 to a Textual Outline 26 using a Storyline Generator 32 that structures the Basic Idea 12 into a Set, Series or Sequence of Elements 34 and applies a KeyConcepts Multiple Query 36 to these Elements 34 in Module A. A set of Textual Outlines 26 based on the number of Sequence of Elements is used to structurally format a blank transparent Architectural Blueprint 54 and File Folder Structure based upon the referenced coordinates of the Architectural Blueprint 54 in Module B. The Architectural Blueprint 56 is populated with the set of Textual Outlines 26 providing an expanded textual description of the Basic Idea 12. A pictorial representation of this textual description is created by developing a set of Trans-Snips 58 using a PictoLayer Generator 60. Using a PictoComposite Generator 62, the Trans-Snips 58 are layered to create a set of Composite Images 61. The Architectural Blueprint 56 is populated with these Composite Images 61 forming a PictoStory Blueprint. Using the Production Control Tools 27 of the Blueprint Generator 52 Alternative Components 64 related to the KeyConcepts are presented using a Data Store Resource 66 to allow for the replacement of Components and Sub-Components to transform the Basic Idea 12 infinitely variable characters, settings and outcomes. Enhancements 67 using an Enhancements Generator 68 are also applied to amplify expand and enhance the PictoStory. Production and Presentation Control Tools 27 within Module C transform the PictoStory into a dynamic, E-Enhanced Multi-Dimensional PictoStory Presentation that may rendered partially or in its entirety using three access formats, Activation 74, WebliZation 76 and WebliCation 78.

Application Software Computer Platform

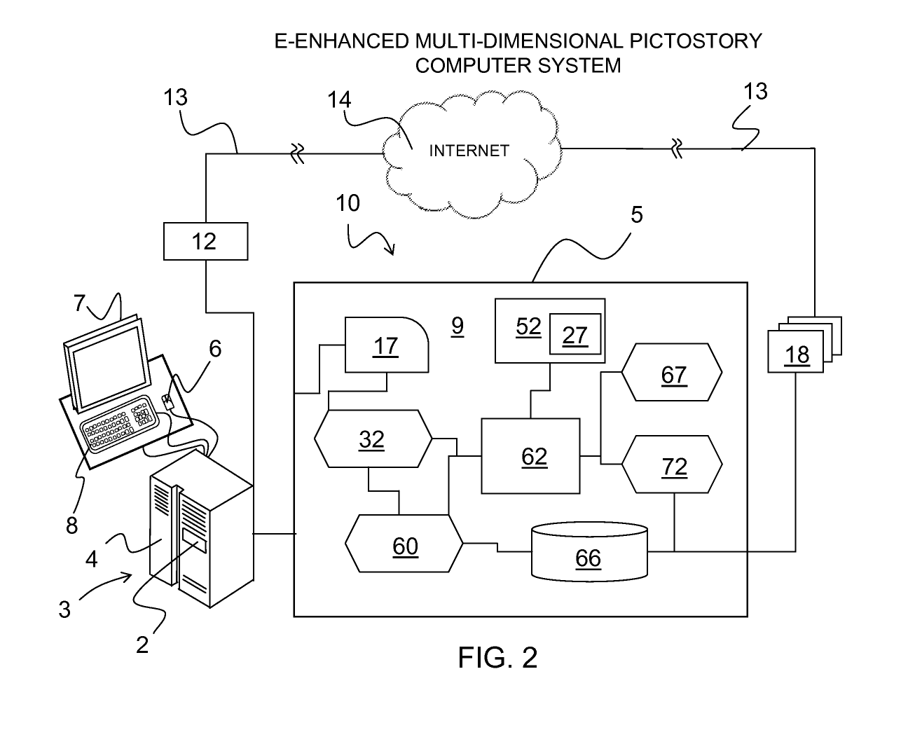

As shown in FIG. 2, in a first embodiment the E-Enhanced Multi-Dimensional PictoStory Application Software may be implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a user to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the processor unit 5 may be programmed, as is well known in the art, for storing the software program internally. A printer or other output device can also be connected to the processor unit 5 for printing a hardcopy of the display from the computer system. The processor unit 5 can have a network connection 13, such as a telephone line, network cable or wireless link, to an external network, such as a local area network or the Internet 14.

The output device 7 provides visually to the user transactional, interactive or variable data that has been Subject to transformations. The output device 7 can be a monitor or other visual computer screen or graphical user interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 can store a computer program product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection. One or more of the devices to access the application software may be connected wirelessly, such as by a cellular link, either directly or via a network. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject a result, or may be assisted by data or metadata (data or metadata that may be user supplied, supplied by another computer program or database from a different application or determined by an algorithm). Moreover, the algorithm(s) may interface with a variety of workflow user interface schemes.

In the following description, some features are described as “software” or “software programs”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Implementation of the present invention may be in conjunction with one or more database management systems (DBMS) such as Oracle, IBM DB2, Microsoft SQL Server, PostageSQL, MySQL, or others using widely supported database languages such as SQL to define and manipulate data and perform data queries. Other aspects of such algorithms and apparatus, and hardware and/or software for producing and otherwise processing the data involved therewith, not specifically shown or described herein may be selected from any such systems, algorithms, Components, and Elements known in the art. The present invention may further be implemented on a secure web server 9 using SSL, SHTTP or other security protocols for encryption and decryption of transmitted data. Data replication and redundancy is performed automatically and all servers are secured in optimal conditions. Further security is provided where each story project is setup using a unique domain name that is accessible only using login identifications and passwords. User logins and preferences link specific user information to their user identification to provide predetermined access to information for each user. Administrative tools within the application software 17 monitor, add or remove users, manage content and set restrictive/predetermined access parameters to users of the system. The access parameters within Module C 70 as described in further detail herein may be in one of three formats of Activation 74, WebliZation 76, or WebliCation 76 This controlled access may further provide data files 18 from the Internet 14 or an intranet to be categorized and stored within the Data Store Resource 66.

### Details of Module A: Storyline Generator

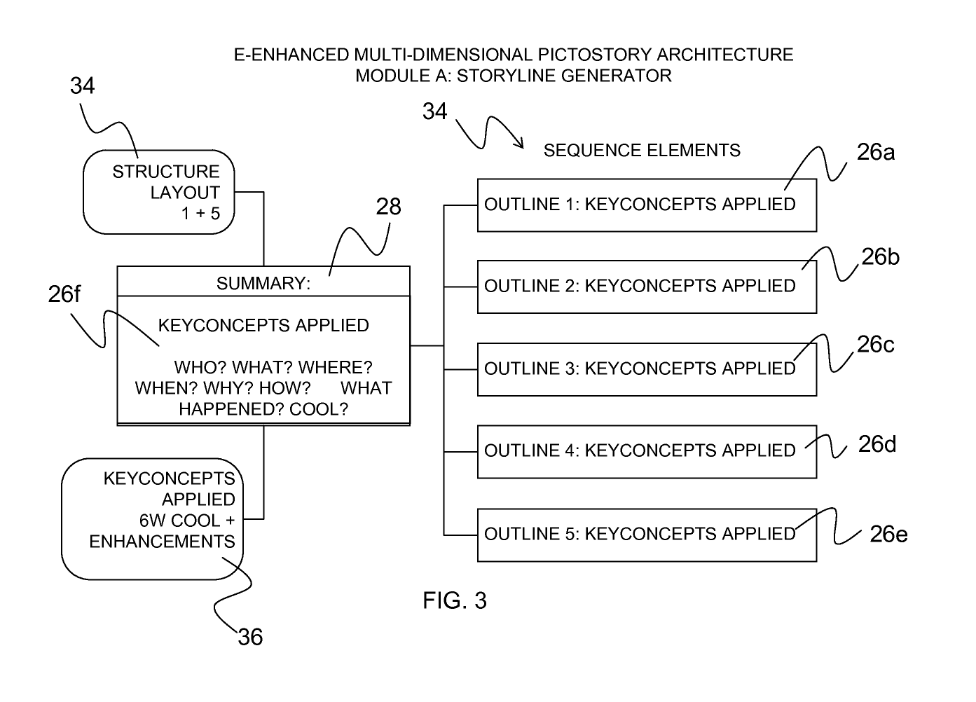

In a first illustrative embodiment, the Storyline Generator 32 as a key first component of Module A of the present invention automatically structures data entered as a Basic Idea 12 that may be presented as an outline, a story, a single topical sentence or even as a single word, into a format necessary for transformation within the E-Enhanced Multi-Dimensional PictoStory Application Software 10. Using the Storyline Generator 32, the Basic Idea 12 is structured into a Set, Series or Sequence of Elements 34 and a Summary 28. The Elements 34, may be structured into any appropriate number based upon the complexity of the Basic Idea 12. A KeyConcepts Query 36 is applied to each structured Element 34 and to the Summary 35 to extend the Basic Idea 12. Shown in FIG. 3 as an example, the Basic Idea 12 is structured into Five Sequence Elements 34 and the KeyConcepts Query 36 is applied. The KeyConcepts Query 36 may be in any inquisitive format, or data entry template, or any other data collection structure to expand upon the Basic Idea 12.

In a first example, a KeyConcepts Query 36 presents a group of questions such as; who?, what?, where?, when?, why? and what happens? or other queries based upon the Basic Idea 12 and structured Elements 34. This series of questions of the KeyConcepts Multiple Query 36, may be referred to herein as 6W COOL questions because of the breadth of information that may be gathered through this structured query format. Information gathered may include geographical location, reference and context to an historic event, date, time, weather, season and other contextual variables; the participants or characters and information about each character, and the events, actions and outcomes that occur within the Sequence of Elements 34. Using the Storyline Generator 32, the KeyConcepts Query 36 may be structured and the information may be gathered in any format. The gathered information data is then transformed into a group of expanded Sequence Element Textual Outlines 26a-26e and a Summary Outline 26f with each outline associated with each of the Sequence of Elements 34 and the Summary 35.

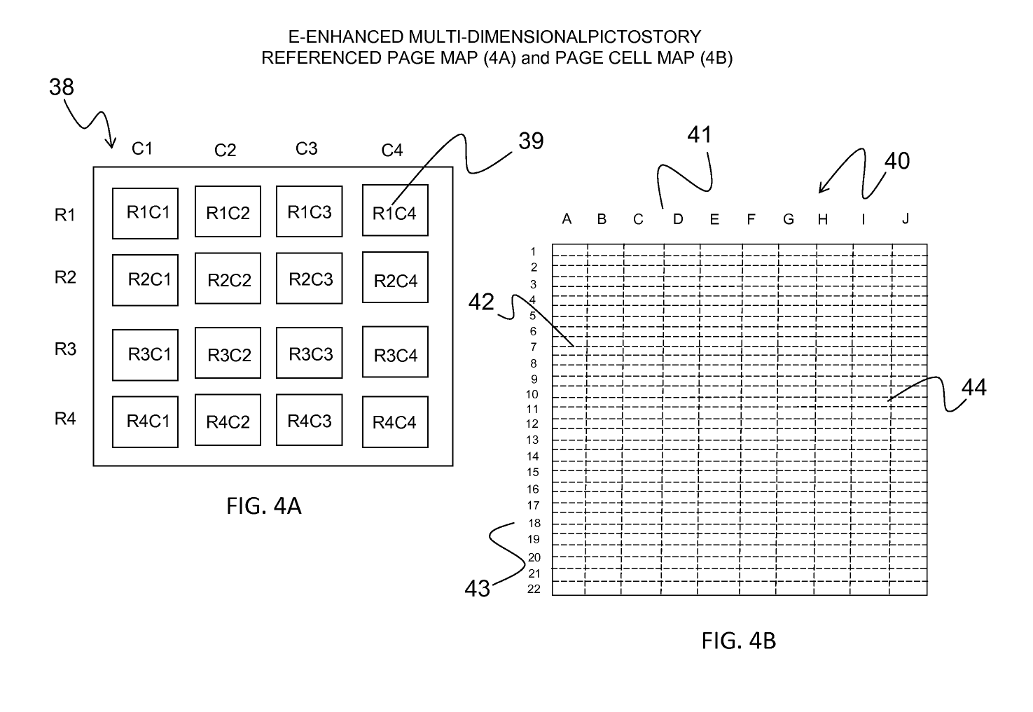

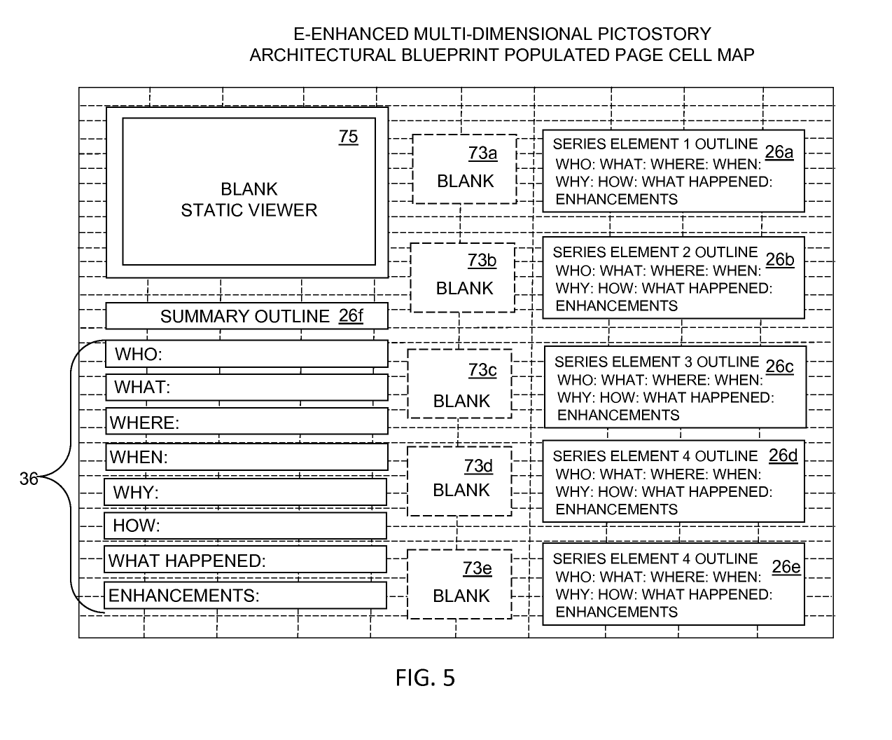

A blank Architectural Blueprint 54 is formatted with a Blank Referenced Page Map 38 and Blank Referenced Page Cell Map 40 coordinate system as shown in FIG. 4 based upon the number of Sequence Of Elements 34 and the Summary 35. The Blank Referenced Page Map 38 structures a series of columns and rows that provide navigation to all Pages 39. Both the Page Map and Page Cell Map 40 coordinate system or grid may be “Display Page Driven” in a spreadsheet-like format having an alphanumeric X-Coordinate 41 and a numerical Y-Coordinate 43 with a series of gridlines 42 that form a series of cells 44. The gridlines are dotted to show the transparency of the Blank Architectural Blueprint 54. A data file structure using randomized, scrambled and/or encrypted file names based upon coordinates of the Referenced Cell Map 40 is developed within an active Output File Folder and stored within the Data Store Resource 66. In this way all components and sub-components that populate the Blank Architectural Blueprint 54 are given files names corresponding to this formatted Referenced Cell Map 40 with each file name corresponding to an active location within the grid. The Textual Outlines 26 are located within the Referenced Cell Map 40 by designating specific, encrypted grid coordinate file name for each outline and thereby forming a Populated Architectural Blueprint 56 as shown in FIG. 5. Each Textual Outline 26 is structured with the KeyConcepts Query 36 and answers. The boxes labeled as Blank and indicated with numbers 73a-73e are placeholders for a series of Composite Images 61 that are used to pictorially represent the Basic Idea 12 and create the PictoStory. A static viewer 75 to enlarge images may also be accessible within the Populated Architectural Blueprint 56.

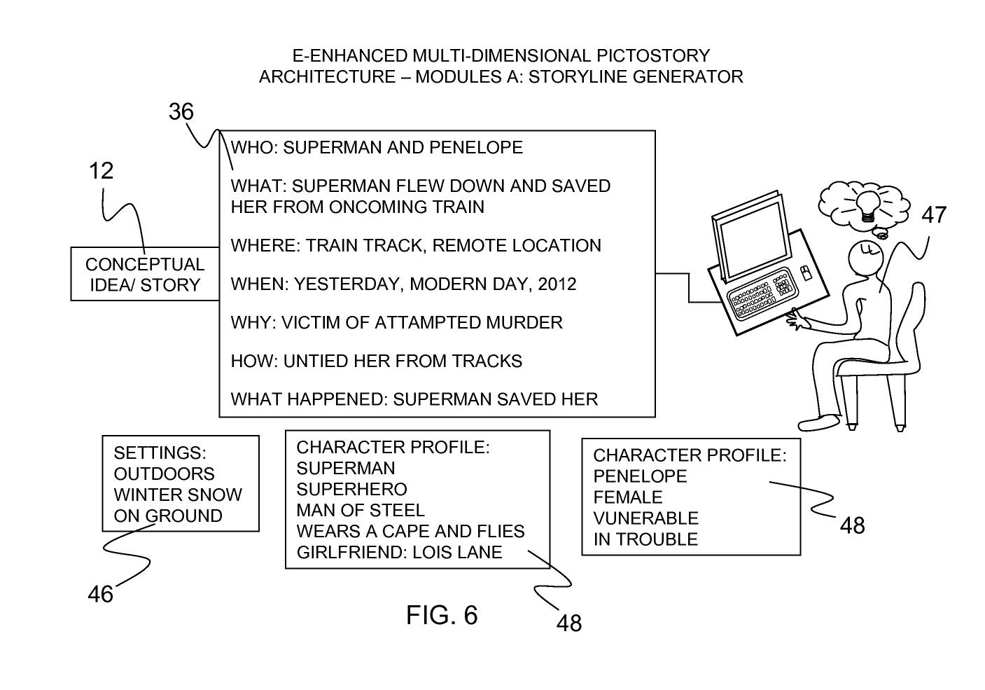

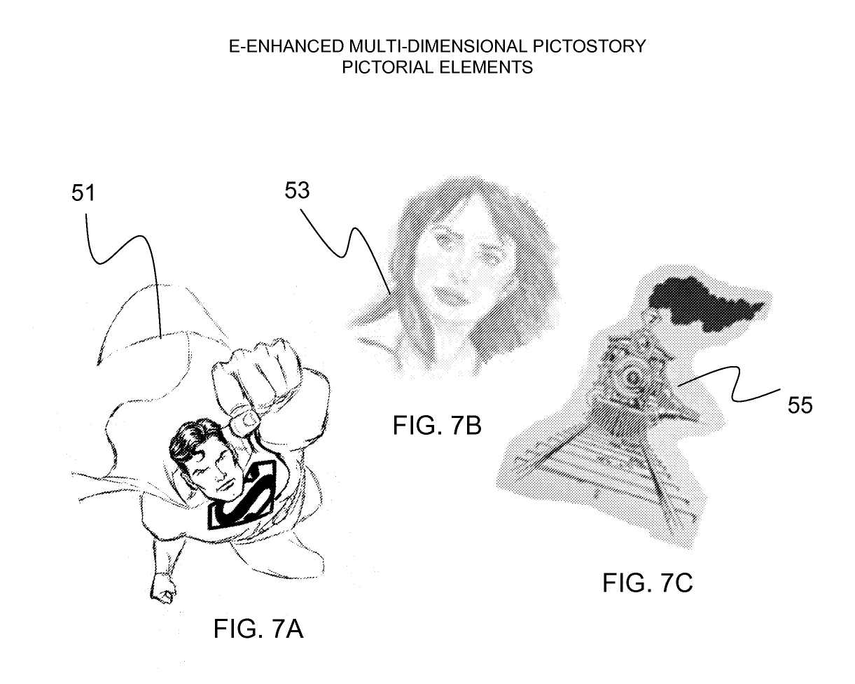

As an example, as shown in FIG. 6, from a single line, such as “Yesterday, Superman swooped in and untied Penelope from the train tracks saving her from the oncoming train . . . ”, the Storyline Generator 32 structures the data input 12 into a Textual Outline 26 by answering the questions who? Penelope and Superman, what? Superman saves Penelope, where? On the train tracks, When? Yesterday, How? Superman untied her from the tracks. A user 47 provides the answers to the questions of the KeyConcepts 36. The KeyConcepts 36 or answers may as an example be grouped or formatted to create a group of settings 46 or one or more character profiles 48 to expand on the Basic Idea 12 and aid in the selection of Pictorial Elements 21. In this example as shown in FIGS. 7A-7C, to pictorially represent Superman's saving Penelope, Pictorial Elements 21 are selected and used to show the event, action and results of the interaction of the characters within the scene. In this basic example, Superman 51 is shown flying to the scene to save the beautiful Penelope 53, who is in imminent peril from the approaching train 55. The pictures give depth and context to the storyline and engage a viewer to have an interest in what happens next.

### Module A: KeyConcepts Query

It is important to note, that the data input for the Storyline Generator 32 may vary from a simple word (e.g. XMAS), to the simple description of the actions of a superhero, to a much more elaborate, thorough description of the Basic Idea 12. In any event and in all cases, the story is still subjected to an expansion and transformation process that structures the Basic Idea 12 into a Sequence of Elements 34 and applies a KeyConcepts Query 36 that may use the 6W COOL questions to transform the Basic Idea 12 to generate a set of expanded Textual Outlines 26. In this example, the gathered information is somewhat limited in the depth and breadth of the story content, and therefore the structuring of the Basic Idea 12 into the series of Sequence Elements 35 and the application of the KeyConcepts 36 expands the Basic Idea 12 with additional gathered information to create a set of much more elaborate Textual Outlines 26.

Data entry fields and dialog boxes may be provided to enter answers to the KeyConcepts Query 36. The KeyConcepts Query 36 may further provide data entry fields for entering alternative and optional answers for example to the 6WCOOL question, Where? May have multiple answers and so an option is provided to enter different optional geographical locations. Paris and Hong Kong may both be entered as an answer leaving options to select one or another or other alternatives at a later time. The entered textual data is then transformed using the Storyline Generator 32 to broaden the contextual scope and to provide more complete and definitive textual information about the Basic Idea 12.

In this example, the 6WCOOL questions of Who, What, Where, When, Why, How, and Wow (What Happens Next) may be used. However, the questions used and formatted within the KeyConcepts Query 36 may vary greatly with different subject matter. As an example, if the Basic Idea 12 is related to a piece of music, then the questions may relate to musical instruments, tempo and arrangement. If the Basic Idea 12 is scientific then the questions may relate to features within a specific technology or field of study. The Basic Idea 12 may further be a script for a full-length feature film that is in the process of seeking investment for production of a film. Therefore the KeyConcepts Query 36 of the E-Enhanced Multi-Dimensional PictoStory Application Software 10 may be in any adequate format as required by the Basic idea 12. The Application Software 10 may further provide for the interactive development of a story where a user may make selections of characters, settings, actions and outcomes based upon a selected Basic Idea 12. Using an appropriate KeyConcepts Query 36 assures that the original Basic Idea 12 maintains a flow and storyline structure and that critical information required by the system 10 is provided.

### Module B: Data Store Resource

The Textual Outline 26 is the basis for selecting the visual content that will be used to pictorially represent the Basic Idea 12 to create a PictoStory. Through an analysis of the gathered information of each Textual Outline 26, a series of Raw Images 79 are grouped and structured into categories within the Data Store Resource 66. The Raw Image categories are structured according to one or more topic questions from the KeyConcepts Multiple Query 36. A group of Raw Images 79 representing one or more responses to the KeyConcepts Query is presented on a displayable format called a Montage 80.

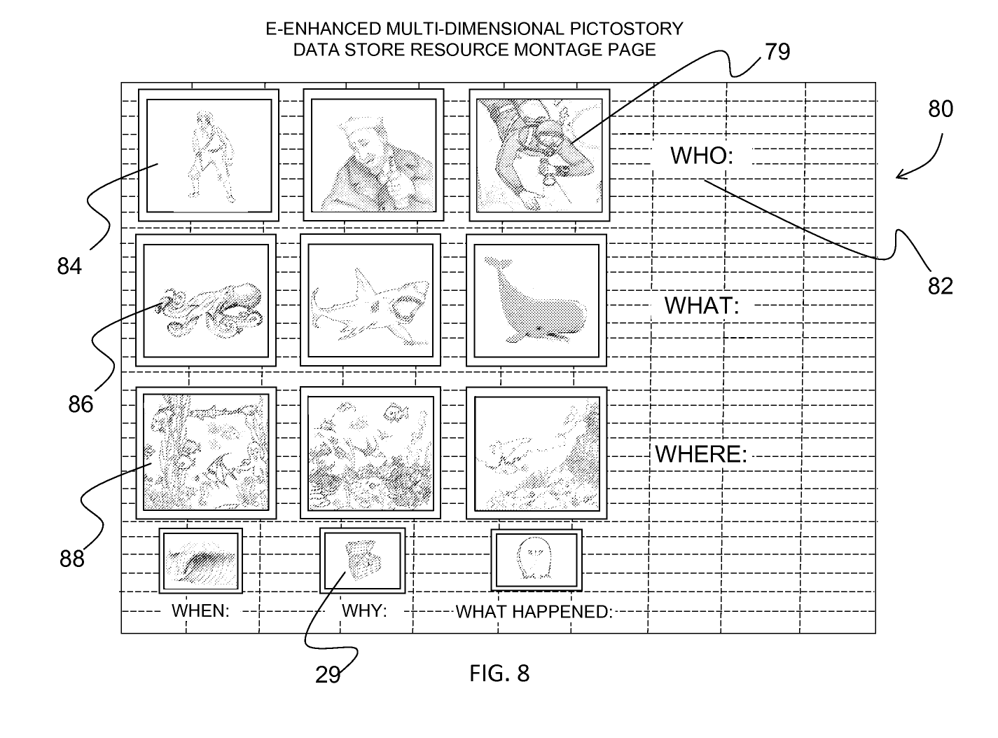

In a first example shown in FIG. 8, a group of nine images are displayed with a KeyConcepts indicator 82 to assist in navigation of the Montage Pages 80. In this example, nine Raw Images 79 are shown in a 3×3 matrix format. The KeyConcepts Indicator 82 displays the 6WCOOL question into which the set of Raw Images 79 have been grouped. The top row 84 displays characters that represent answers to the Who questions of the Basic Idea. The middle row 86 displays sea creatures that represent the What that may become the action for what may happen, i.e. the deep sea diver of the top row may be attacked by a shark. The bottom row 88 represents the Where and displays a series of Raw Images 79 showing underwater environments. Additional Navigation Tools 29 of the Blueprint Generator 52 are accessible within the Montage Page 80 to provide access to other Montages 80 of other KeyConcepts 36. Using the PictoLayer Generator 60 Raw Images 79 may be selected from the Montage Pages 80 to be used in the E-Enhanced Multi-Dimensional PictoStory.

The PictoLayer Generator 60 is structured with many critical and unique formatting tools that transform Raw Images 79 presented in any of a number of formats (jpg, bmp, GIF, TIFF, etc.) to Pictorial Elements 21 that are positioned and used within layered Composite Images 61. The PictoLayer Generator 60 deconstructs the Textual Outline 26 and collects information on the Basic Idea 12 from the answers to the KeyConcepts Query 36. For each answer within each of the Sequence of Elements, a Raw Image 79 is selected from the Montages 80 of the Data Store Resource 66. In the example of a set of five elements and using the eight 6WCOOL questions forty or more Raw Images of well-suited pictorial content may be selected to exemplify the Basic Idea 12 of each KeyConcepts 36. However, the Pictorial Elements 21 from the Raw Images 79 are not simply presented in a static or fixed manner such as in a slideshow, but instead the E-Enhanced Multi-Dimensional PictoStory Software 17 extends the KeyConcepts 36 by generating a layered Composite Image 61, with each layer and Pictorial Element within a layer available to be associated with Enhancements to dynamically present the Basic Idea 12.

### Module B: PictoLayer Generator

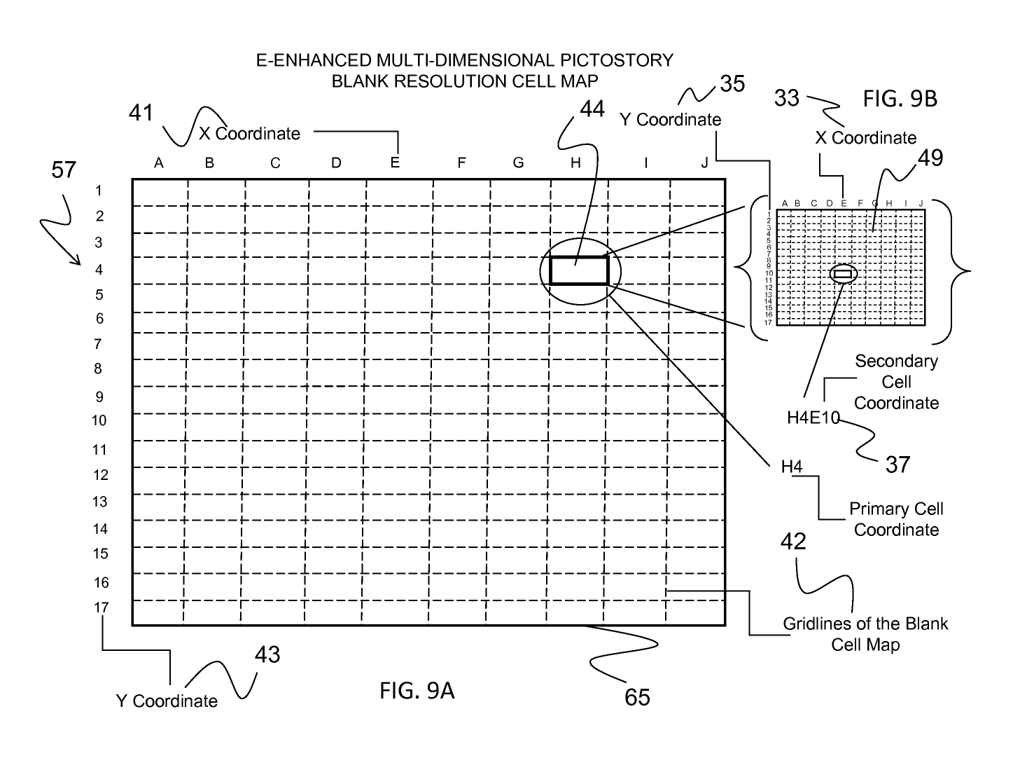

As shown in FIG. 9A, a Blank Transparent Resolution Cell Map 57 is used to locate and display the Pictorial Elements 21 from the Raw Images 79. The reference coordinates may be based on any sub-divided coordinate grid which represents, in this first example, the resolution of the image at a pixel level that in a first example would provide coordinates of 1024×768. Grid coordinates at the pixel level are referred to herein as a Resolution Cell Map 57. The grid may be represented in a spreadsheet type format with an alphanumeric X-Coordinate 41 and a numerical Y-Coordinate 43 with each coordinate defining a cell 44 in a position within the grid 57. The Blank Referenced Resolution Cell Map 57 is shown with dotted grid lines 42 to show the transparency of the entire blank sheet. The gridded coordinates of the Resolution Cell Map 57 allows for association of a reference coordinate of a Pictorial Element 21, and/or an Enhancement 68 to a Trans-Snip 58 or an association of any other Component or Sub-components to the Trans-Snip 58.

In layering one or more Components and Sub-Components, a cell 44 within a primary alphanumeric grid of a Referenced Resolution Cell Map 57, may be further divided into smaller coordinates creating access points within a single 44 cell as shown in FIG. 9B. The further gridding of a single cell creates a secondary coordinate layer such as shown for cell H4 indicated as 44. The secondary coordinates are formed as an alphanumeric/numerical grid 49 with a secondary x-coordinate 33 and secondary y-coordinate 35. A selected access point within the H4 cell is indicated as 44 and denoted as a secondary coordinate of Layer 2: H4E10 indicated as 37. Cells may be divided and layers created down to a pixel level using the Resolution Cell Map providing for thousands of access points within a single cell that may be used to link the cell to a Pictorial Element 21, Trans-Snip 58 or an Enhancement 67 as described in further detail herein.

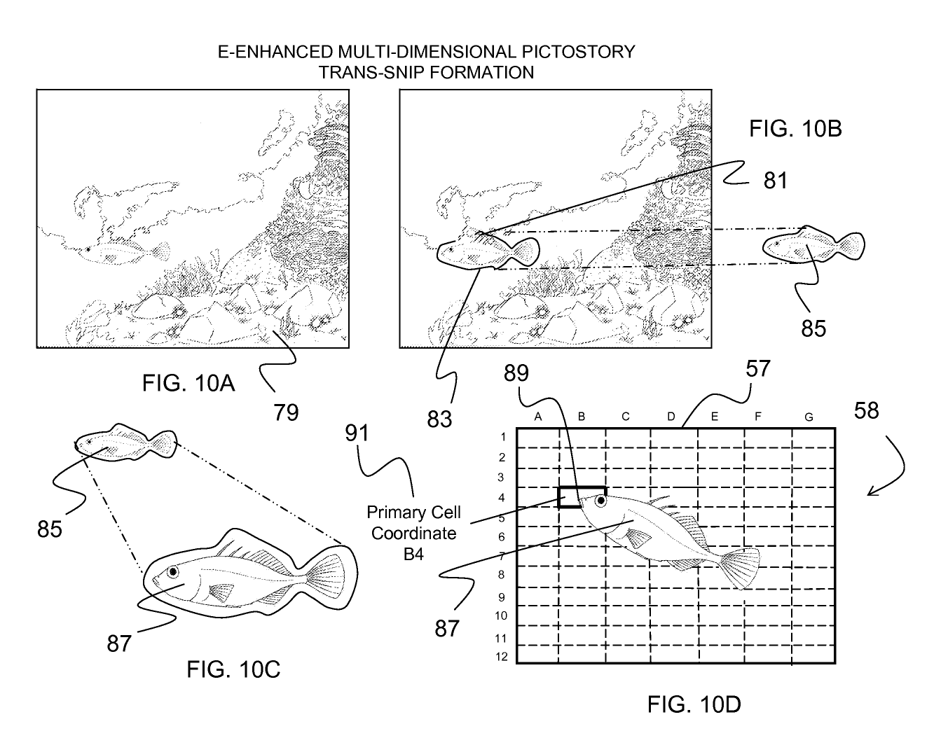

As shown in FIGS. 10A-10D, a Raw Image 79 may be acquired from the Data Store Resource 66 using the PictoLayer Generator 60, and a portion of that image 79 may be used to contribute to present the contextual content of the KeyConcepts 36. As shown in FIG. 10B, a cutting tool 81 allows for a portion of the image to be traced and cut out from a Raw Image 79. The Raw Image 79 may be shape cropped into multiple possible shapes including freehand, oval, rectangle, etc. In this example, a fish is outlined 83 and cut out in a fish shape 85 and dragged out of the image 79. The shape cropped image 85 is resized to any desired dimension within the horizontal and vertical limits of the parameters of the transparent blank resolution specifications. In this example, the fish cut out 85 is enlarged to form the Fish Pictorial Element 87. Software tools within the PictoLayer Generator 60 remove any white background that is created when using the cutting or snipping tool and the Fish Pictorial Element 87 is located on the Transparent Blank Referenced Resolution Cell Map 57. The Fish Pictorial Element 87 may further be rotated in any direction and then be given a cell reference location on the Transparent Blank 57 by aligning for example its furthest left highest point 89 to indicate in this example, the coordinate position of B4 indicated as 91 within the Resolution Cell Map 57. The resized, shaped cropped image with the white background removed and located at a reference coordinate on the Transparent Resolution Cell Map 57 forms a Trans-Snip 58.

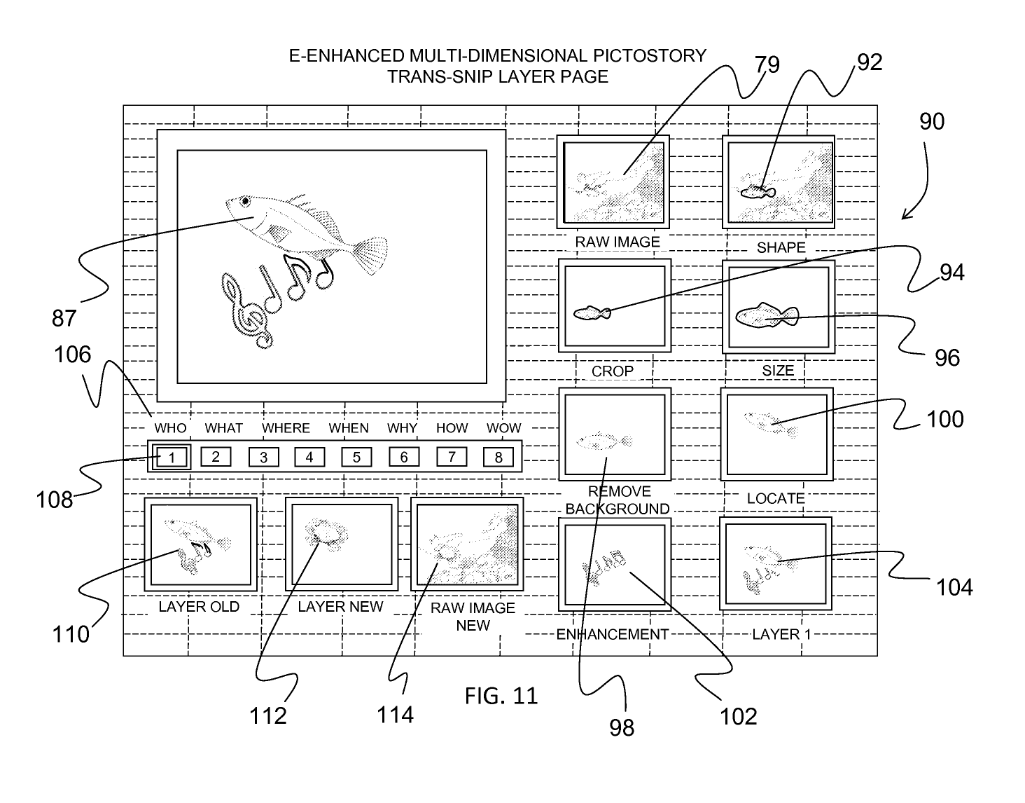

The process and sub-components of a Trans-Snip 58 including the Raw Image 79 is displayed within the Populated Architectural or PictoStory Blueprint 56 on a layered Trans-Snip Page 90 as shown in FIG. 11. Each process step is displayed including the shaping of the image 92, the cropping of the image 94, the sizing of the image 96, the removal of the white background 98, locating the image on the Resolution Cell Map 100, associating the image with one or more Enhancements 102, and forming the Trans-Snip layer 104. Using the Production Controls 27 of the Blueprint Generator 52, the Trans-Snip Page 90 further provides KeyConcepts Indicators 106 and a Navigation Toolbar 108 to select a process step image. Alternatives for each layer are also displayed with the Current Component layer 110, the Alternative Component layer 112, and the Raw Image of the Alternative Component 114.

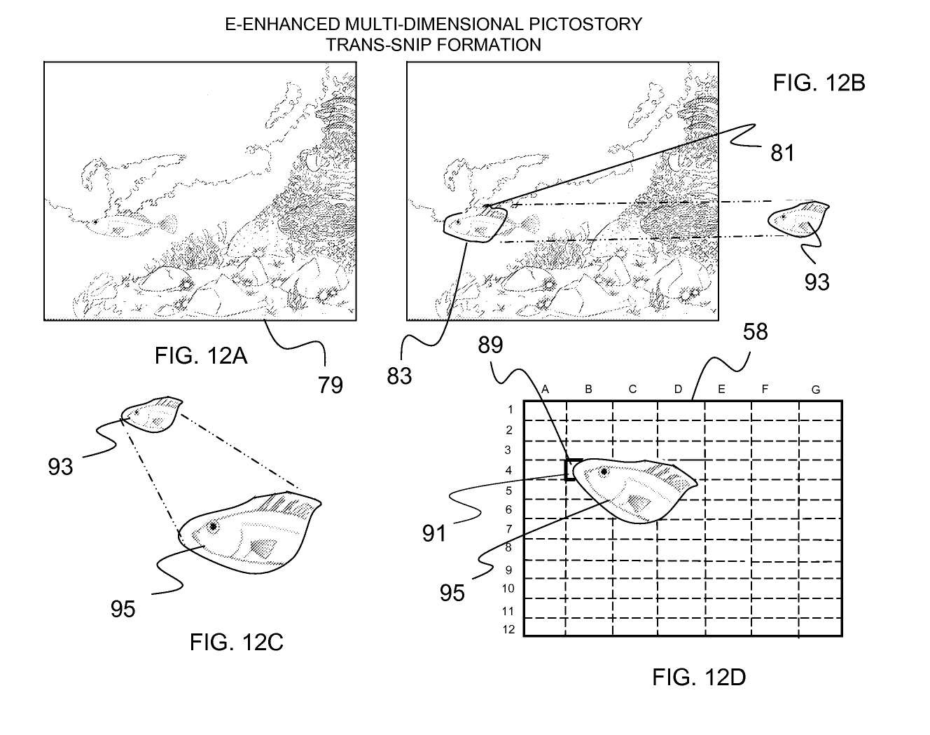

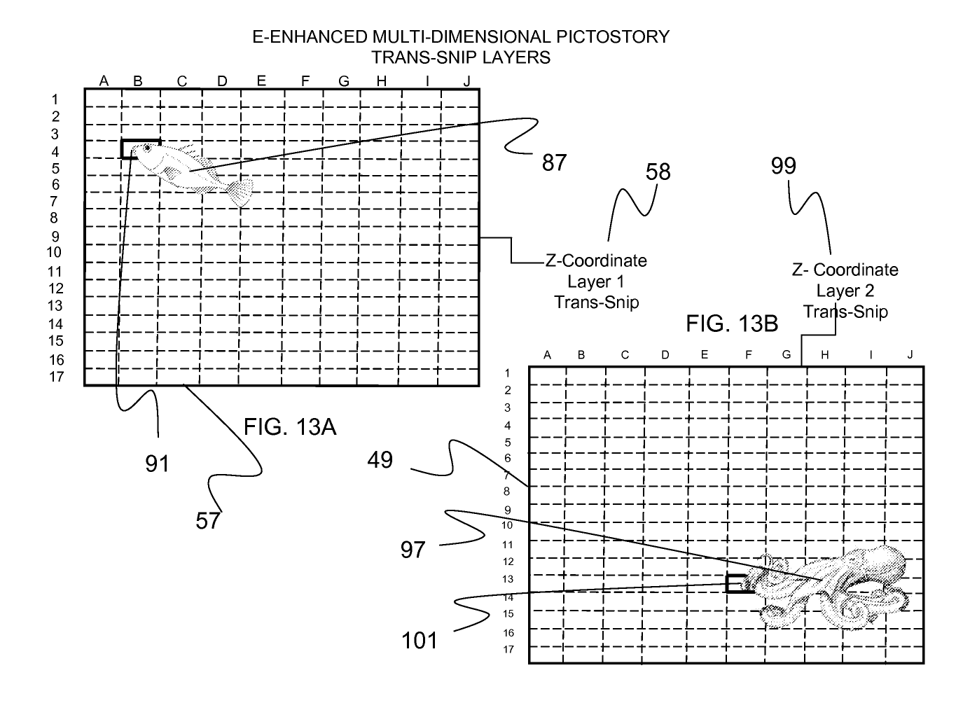

As shown in FIGS. 12A-12D, the cutting tool 81 may be used to cut out only a portion of a Pictorial Element 21 in any desired shape. This important feature allows for a number of Pictorial Elements 21 to be placed in a series of Transparent Resolution Cell Maps 57 using the PictoLayer Generator 60, and be layered with the portions of Pictorial Elements 21 shown through each of Transparent Cell Maps 57. In this example, the fish cutout 93 is cut in a different shape with only a front portion of the fish showing. The cut out 93 is then enlarged to the Pictorial Element 95 and the white background is removed and it is placed on the Blank Resolution Cell Map 57 forming a Trans-Snip 58 with its upper left most edge 89 determining the cell coordinate B4 indicated as 91.

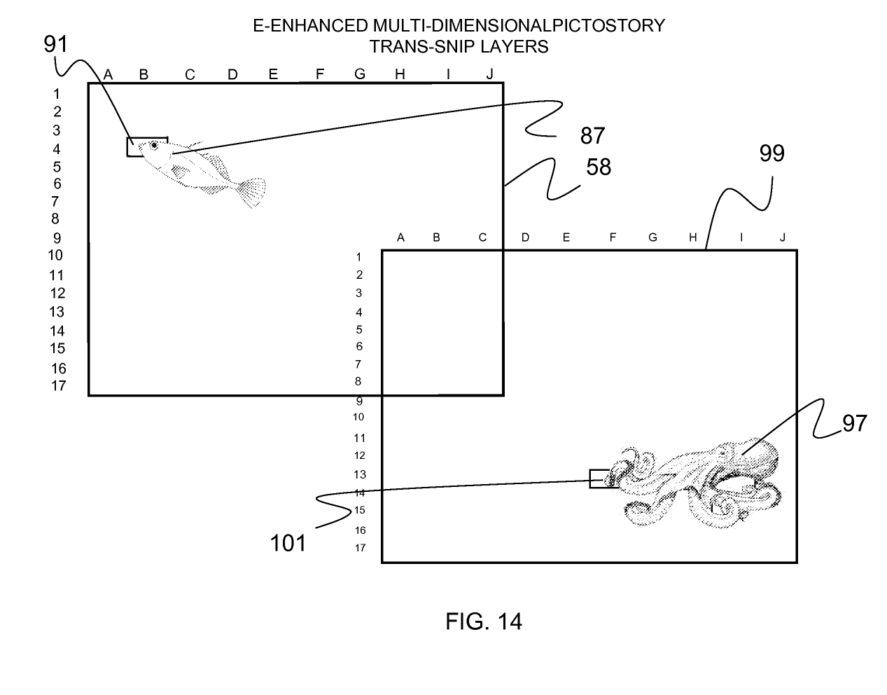

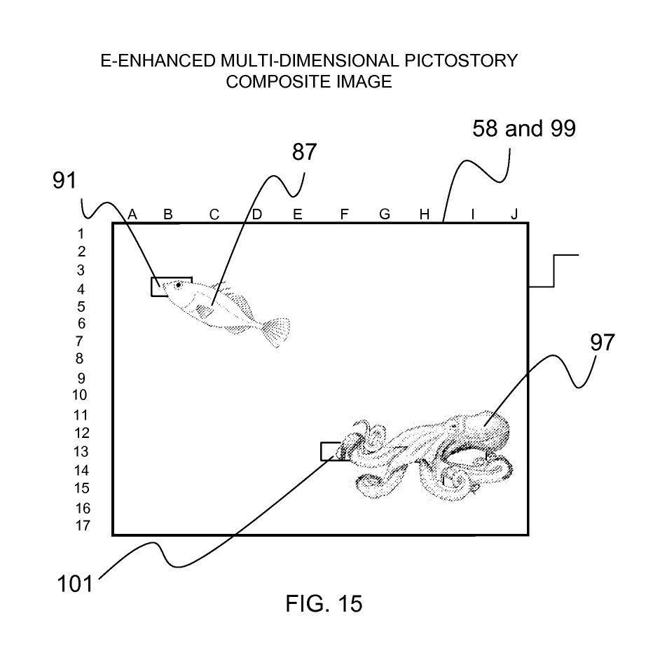

In locating the Fish Pictorial Element 87 on a Transparent Resolution Cell Map 57, shown in FIG. 13A, a Trans-Snip 58 is formed with a grid location B4 indicated as 91. As shown in FIG. 13B, a second Trans-Snip 99 is formed by locating a second Pictorial Element 97, in this example an octopus, at grid position F13 indicated as 101 on a second Blank Transparent Resolution Cell Map 49. As shown in FIG. 14, the gridlines 42 are optionally visual and may be removed and the first and second Trans-Snips 58 and 99 may be overlaid. As shown in FIG. 15, aligning the first Trans-Snip 58 as layer 1 over the second Trans-Snip 99 as layer 2 allows for the Pictorial Element 97 of the second Trans-Snip 99, the octopus, to be seen through the first Trans-Snip 58. For each Trans-Snip the layer becomes a Z-Coordinate within the Architectural or PictoStory Blueprint Referenced Cell Map 124.

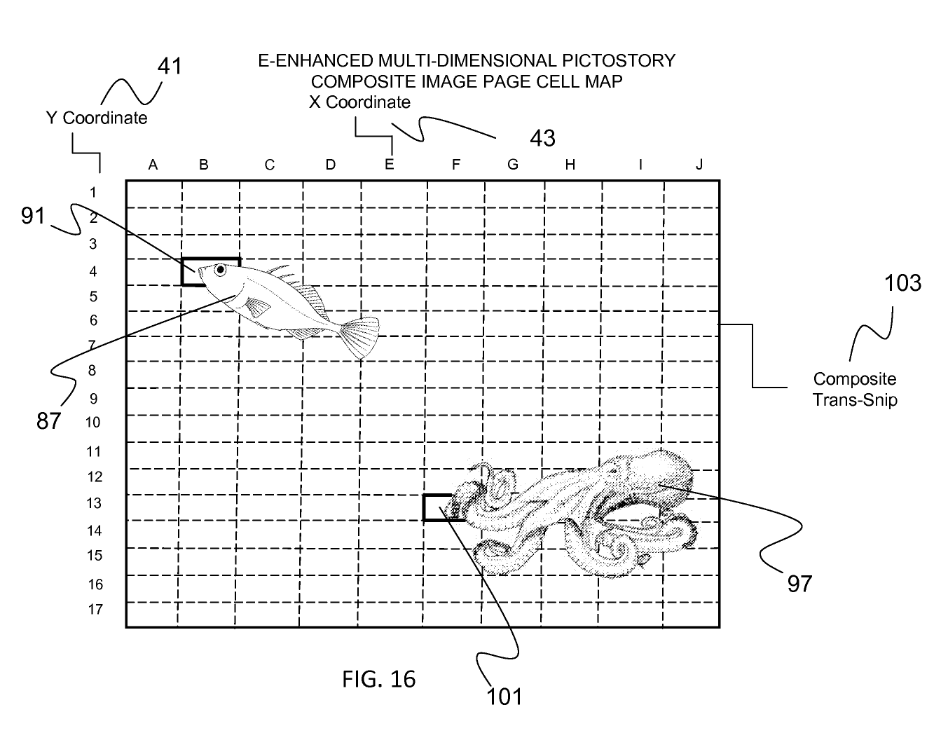

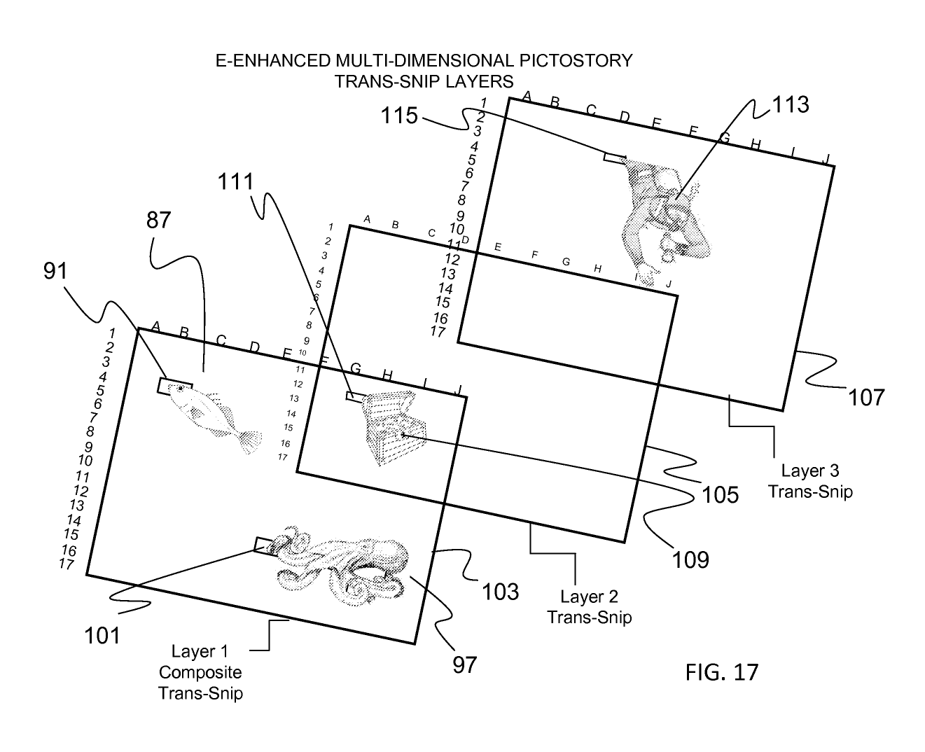

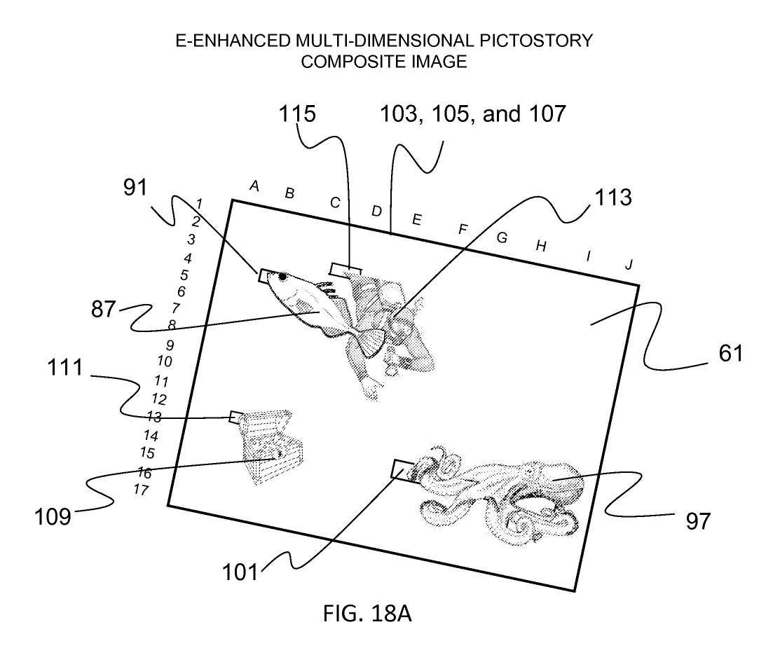

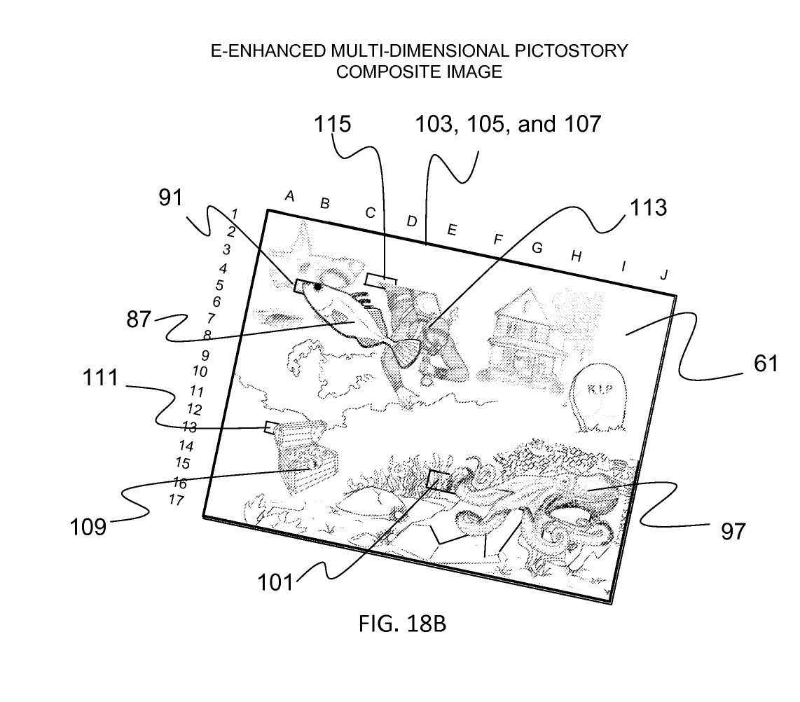

As shown in FIG. 16, one or more Pictorial Elements 87, 97 may be located on the same Transparent Blank Resolution Cell Map 57 forming a Composite Transparent Resolution Cell Map or Composite Trans-Snip 103. Each Pictorial Element 87, 97 has a separate grid location within the Composite Trans-Snip 103 as shown with a first Fish Pictorial Element 87 in this example having a location of B4 indicated as 91 and the second Octopus Pictorial Element located at G13 indicated as 101. Forming composite Trans-Snips may be advantageous when connecting a theme with an event to convey a specific time and place such as an athletic stadium during the 2012 London Summer Olympics. The branding trademark for the 2012 Olympics may be shown as a first Pictorial Element and the athletic stadium as a second Pictorial Element, thereby conveying the time and place of the event that occurs in the athletic stadium. As shown in FIG. 17, a composite Trans-Snip 103 may be overlaid by or layered over any number of Trans-Snips 58 to create a layered Composite Image representing the KeyConcepts 36 within one of the Textual Outlines 26 of one of the Series of Elements 34. In this example, additional Trans-Snips 105 and 107 include the Pictorial Elements 21 of a treasure chest 109 located at F8 indicated as 111 and the Pictorial Element of a scuba diver 113 located at B7 and indicated as 115. FIG. 18A shows the aligned overlay of the three layers of Trans-Snips and FIG. 18B shows the overlay with additional Trans-Snips 58 and a Raw Image 79 background.

### Module B: PictoComposite Generator

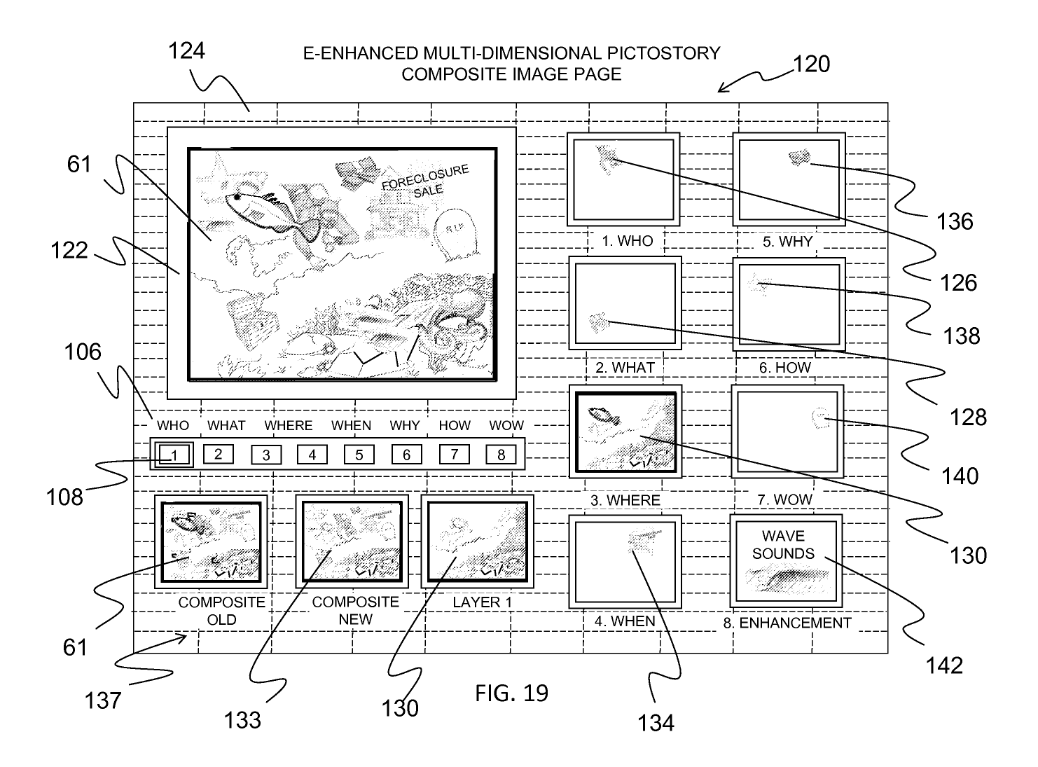

Using the PictoComposite Generator 62, a layered Composite Image 61 is formed from the layers of Trans-Snips 58. A Composite Image Page 120 is shown in FIG. 19 that includes the layered Composite Image 122 from FIG. 18B and each of the layered Trans-Snip Components and Sub-Components. In addition to the Resolution Cell Map 57, the Composite Image Page 120 provides a second coordinate system, a Referenced Cell Map 124 to navigate and modify the layered Trans-Snips 58 using the Production Tools 27 of the Blueprint Generator 52. Each of the Trans-Snip 58 pictorially represents the Textual Outline 26 of one of the Sequence of Elements 34 to create a Composite Image 61. In this example, the Who response is represented with a sea diver 126, What is a treasure chest 128, Where is an underwater background 130, When shows an event of a foreclosure on a home 134, Why shows a bundle of cash 136, How shows a great white shark 138, What Happened or WOW shows a gravestone 140 and the Enhancement 142 has the sound of waves crashing on the beach dynamically displaying the Basic Idea 12. The Composite Image Page 120 provides KeyConcepts Indicators 106 and a Navigation Toolbar 108 to select and modify a layered Component of the Composite Image 61. The Composite Image Page 120 further provides options for Alternative Components 64 based on the KeyConcepts 36. To select an Alternative Component 64 to replace an Interactive Component a current Composite Image 61 is displayed in the Data Store Viewer 137 with the Alternative Component 133 and the layer of interest 130 to display the appropriate information for replacement.

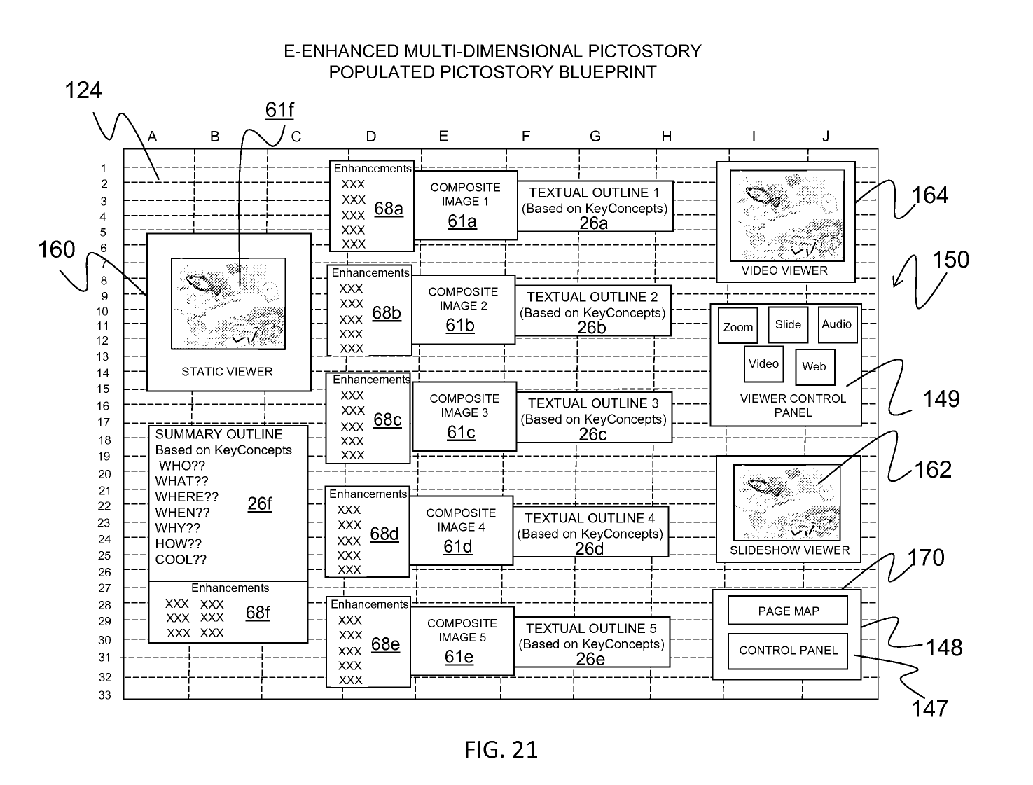

The Multi-Dimensional structure of the E-Enhanced PictoStory provides for direct navigation access to any Component or Sub-Component. Each Pictorial Element 21 has an X, Y and Z Resolution Cell Map Coordinate within each the Trans-Snip 58 and an X, Y and Z coordinate within each Referenced Cell Map 124 of the layered Composite Image 61. This structure further provides for Enhancements 68 to be linked at any Multi-Dimensional level; to any Pictorial Element 21, to any Trans-Snip 58, to any Composite Image 61 or to a group of Composite Images within a PictoStory Blueprint 56 as shown in FIG. 21. The PictoStory Blueprint 56 provides a further coordinate system a Referenced Page Map 170 to further navigate or modify any Component or Sub-Component within the PictoStory.

### Module B: Enhancements

Enhancements 68 are additional information or features associated with the structural Components and Sub-components such as the Pictorial Elements 21 or layered Composite Images 61 using an activation or access point corresponding to a Component or Sub-Component and associated with the Resolution Cell Map 57, the Referenced Cell Map 124, Referenced Page Map 170, a combination of cells, or any blank or populated Referenced Page Map Layer. Enhancements 68 by definition can be any further amplification, pictorial expansion or transition to a Sub-routine or indeed totally different URL or a fully interactive application that are activated and referenced by selecting a button, clicking a mouse, touching a screen or using any other operational control at the appropriate cell mapped reference points on a Trans-Snip 58, Composite Image 61, or PictoStory StoryBoard 150 using the Production Controls 27 of the Blueprint Generator 52. The Enhancement 68 may be in numerous forms, including inter alia: Text, Narration, Music, Song, Slides, Animation, Count, etc. with interactive tools for navigation and data entry where required. This additional enhanced information may be features that add dimension and depth to the KeyConcepts 36 of the Basic Idea 12.

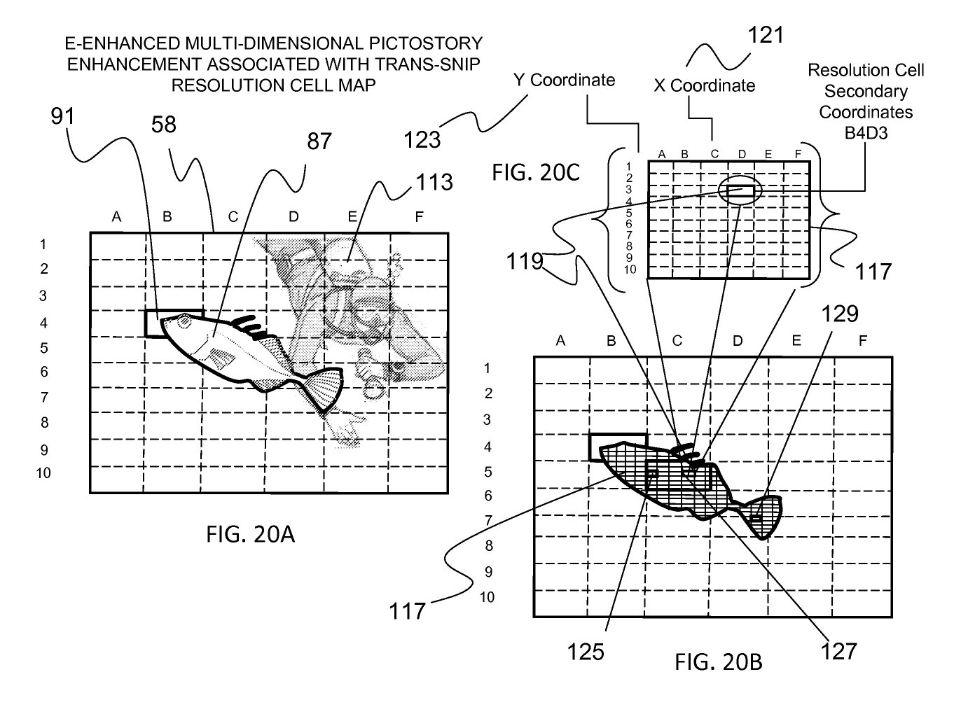

Using the Enhancement Generator, when a Trans-Snip 58 on a first sheet is layered above a second blank transparent sheet or a sheet having one or more Trans-Snips, the Trans-Snips on the second sheet are seen through the transparent sheet of the upper layer, but may be partially covered. In this manner, an Enhancement 68 associated with the upper layer Trans-Snip 58 takes priority over Enhancements 68 associated with cell references on lower layers that are behind the coverage area of the Trans-Snip 58. An activation or access grid, using the Referenced Cell Map 117 with secondary coordinates 119 is associated with the Pictorial Element 87. The secondary coordinates use a similar grid structure with an X-coordinate 121 and Y-coordinate 123 for location of an access point 119, B4D3 in this example, within the Pictorial Element 87. In overlaying the Trans-Snips as layers 1-3, the Pictorial Element 87 of the fish of layer 1 (Z-coordinate 1) covers a portion of the Pictorial Element of the scuba diver 113 of layer 3 (Z-coordinate 3) as shown in FIG. 20A. The upper layer 1 therefore becomes the primary or activated layer and means that the access points 125, 127, 129 and throughout the pictorial area of the Fish Pictorial Element 87 are active with each activation point having secondary coordinates that correspond to an enhancement that is linked to the Pictorial Element 87.

As shown in FIG. 20B, by hovering the mouse 6 or other access control over the Pictorial Elements 87 of the primary layer 1, the Referenced Cell Map 117 appears displaying the activation points shown as 125, 127 and 129. By selecting an access point, an Enhancement is activated to display additional features and information related to the Pictorial Element 87 accentuating the KeyConcepts 36 of the Basic Idea 12. The secondary coordinates B4D3 indicated as 119 for access point 127 are shown in FIG. 14C. The grid coordinates 117 attach to a Pictorial Element 21 within each layer providing a map for access to additional information through the Enhancements with only the primary layer being active. Any Enhancements 68 associated with the Sea Diver Pictorial Element 113 in the secondary layer will not be accessible, however using the Production Control Tools 27 layer ordering and access control may be changed.

Regions that are blank within a transparent cell map also have secondary grid coordinates 37 as shown in FIGS. 9A and 9B. The secondary grid coordinates within a blank region or Pictorial Element 21 are not simply hot regions within a clickable image map that allows for navigation to a web page or website through a hyperlink, but instead the Multi-Dimensional reference maps provide for as many Enhancement links 68 as are desired to be associated with the Component or Sub-Component and therefore for as an example a 10×10 grid within a single cell covered by a Pictorial Element would provide 100 access points for Enhancements 68 to be accessed from the Pictorial Element 21. If desired, the access map may be based on the pixel resolution using the Resolution Cell Map 57 providing for more than 1000 access points for Enhancement links 68 within a Pictorial Element 21 to dynamically present the Multi-Dimensional PictoStory Presentation 72.

### Module B: PictoStory Blueprint

The Textual Outline 26 from the Storyline Generator 32 and the layered Composite Images 61 from the PictoComposite Generator 62 are located within the Architectural or PictoStory Blueprint 56 forming a PictoStory StoryBoard 150 to provide for a User, Developer or other Production personnel to manipulate and extend the KeyConcepts 36 of the Basic Idea 12. Shown as an example in FIG. 21, the Composite Image 61f of the PictoStory Summary from FIG. 19 is located on the Reference Page Cell Map 124 of the PictoStory Blueprint 56. The other Composite Images 61a-61e from the Sequence of Elements 34 structured by the Storyline Generator 32 are also located in pre-formatted locations within the PictoStory Blueprint 56. The PictoStory Blueprint 56 also provides three viewers to view the PictoStory, a Static Control Viewer 160, a Slide Show Viewer 162 and a Video Viewer 164. The layered Summary Composite Image Page 61f is shown statically and enlarged in the Control Viewer 160 for review and editing of its Components and Sub-Components including Trans-Snip Page layers 58 and Enhancements 68 associated with the Composite Image 61f. The Outline Summary 26f of the Basic Idea 12 is provided in this example below the Control Viewer 160 displaying the responses to each of the KeyConcepts 36 using the 6WCOOL questions associated with the Summary Composite Image Page 61f.

Access to the Enhancements 68f for the Summary Page and Enhancements 68a-68e for the other Composite Images 61a-61e are accessible on the Referenced Page Cell Map 124 through access points that are represented as X's. As shown, any Pictorial Element 21, Trans-Snip 58 or layered Composite Image 61 may have multiple Enhancements 68 to expand and extend the Basic Idea 12 of the PictoStory. Access to the Enhancements 68 are designated within the Referenced Page Cell Map 124 as activation points, navigation buttons, hyperlinks or other markers that when selected run the Enhancement 68. Alternatively, the Viewer Control Panel 149 provides tools to render and activate all or a portion of the E-Enhanced Multi-Dimensional PictoStory Presentation 72. The rendering of the Presentation 72 activates the associated Enhancements 68 to run any Subroutine, Software Application, URL, linkage, or other types of File Formats to add and amplify information available or associated with the KeyConcepts 36. A Navigation Menu 147 provides access to the Reference Page Map 170 referred to herein as the PictoStory Wall and to the Production Control Panel 148 within the PictoStory Blueprint 56.

### Module B: PictoStory WALL—Reference Page Map

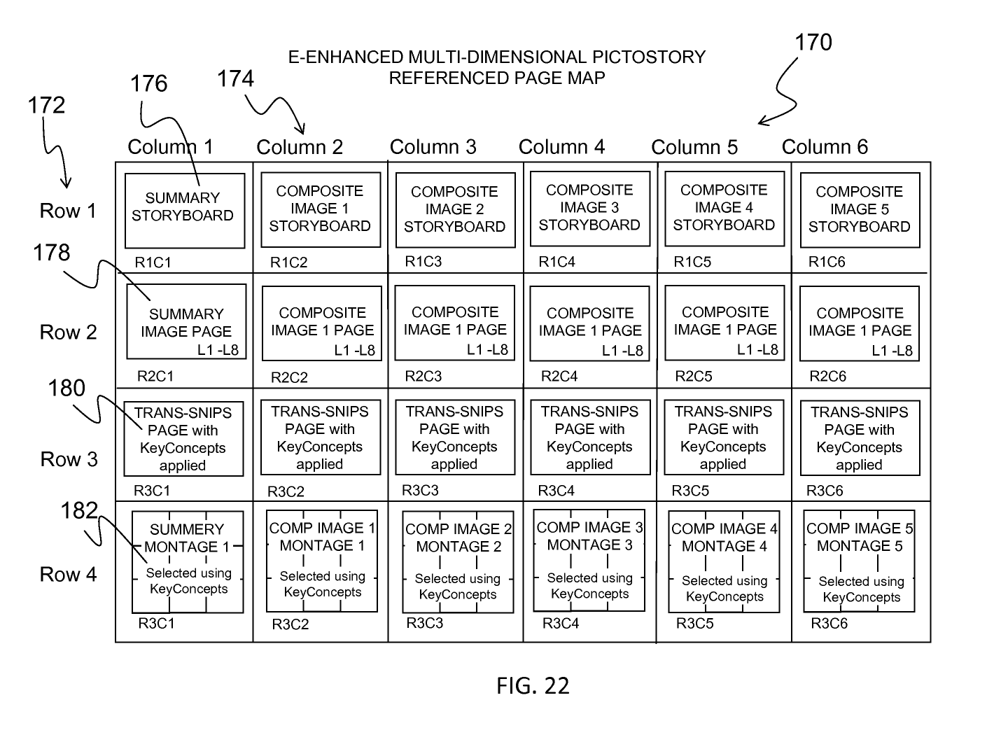

Navigation controls are available using PictoStory Reference Page Map 170 or PictoStory Wall that provides access to each Component and Sub-Component as well as access to activate, review, link and modify each Enhancement 68 to expand and amplify the Multi-Dimensional PictoStory Presentation 72. As shown in FIG. 22, the PictoStory Wall 170 displays a series of iconic representations that when selected, open the selected Component. In a first example, the PictoStory Wall 170 is structured in a matrix grid of rows 172 and columns 174 with an iconic representation for the Summary and each Composite Image Page 120, each Trans-Snip Page 90 and each Montage Page 80. However, any number of pages having other Components may be located within the PictoStory Wall 170. In viewing the PictoStory Wall and zooming out from the view, the top row of Pages going across are the Summary and Set of Composite Images. The Columns of Pages, going down under each Composite Image represent the construction of the Layers. Hence, the PictoStory Blueprint is a Referenced Page Map and each component page is a Referenced Page Cell Map describing sub components of the Layers and Composite Images.

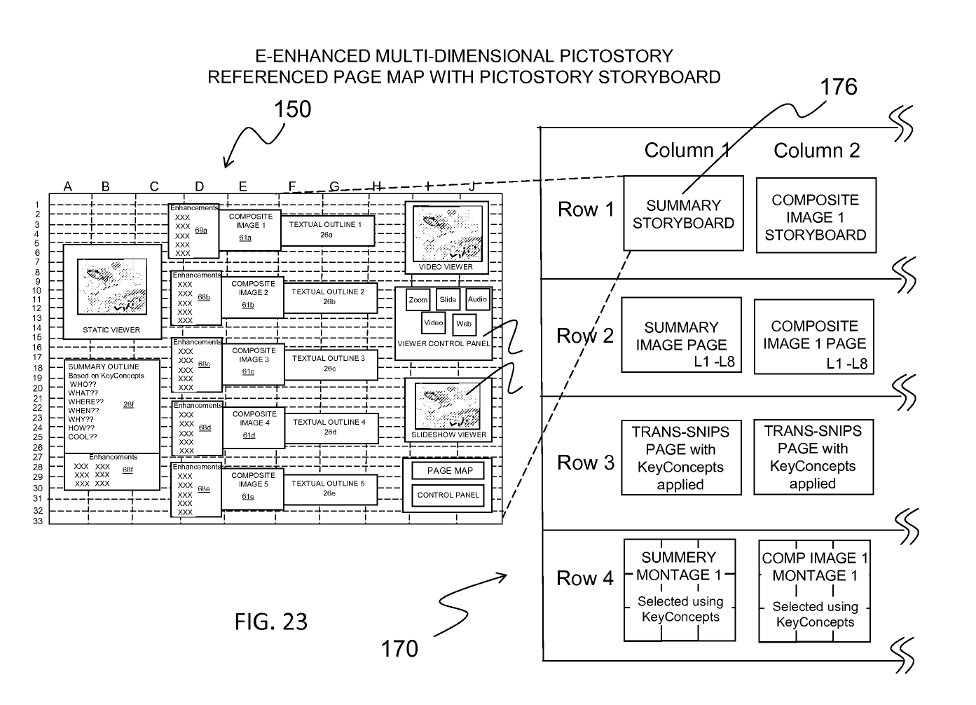

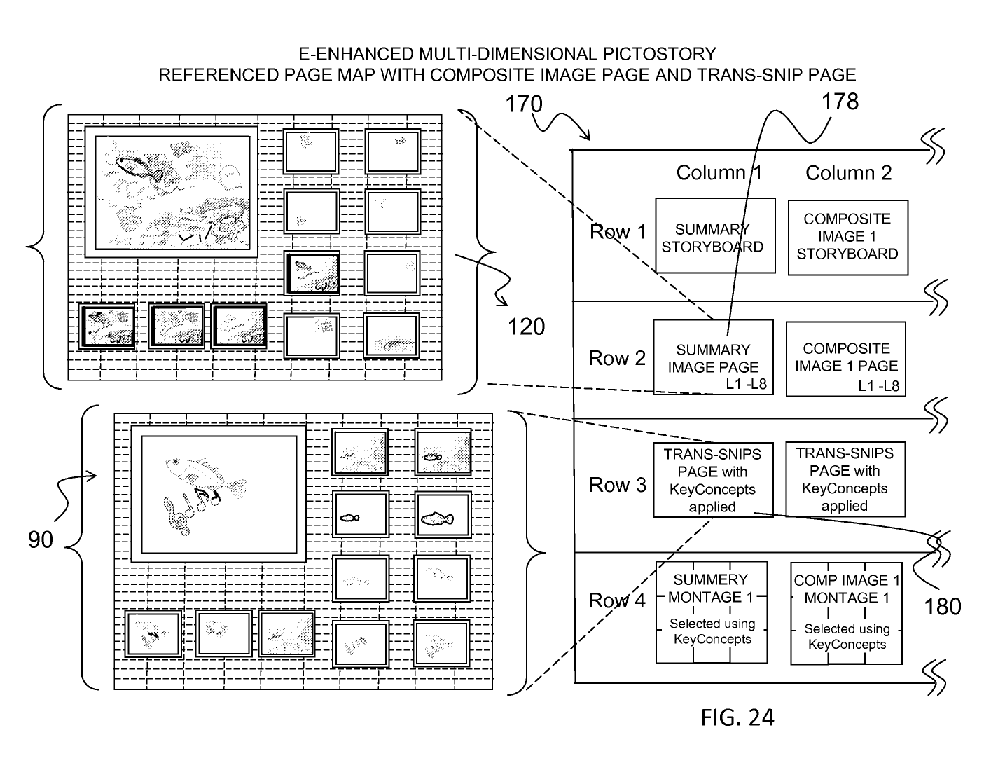

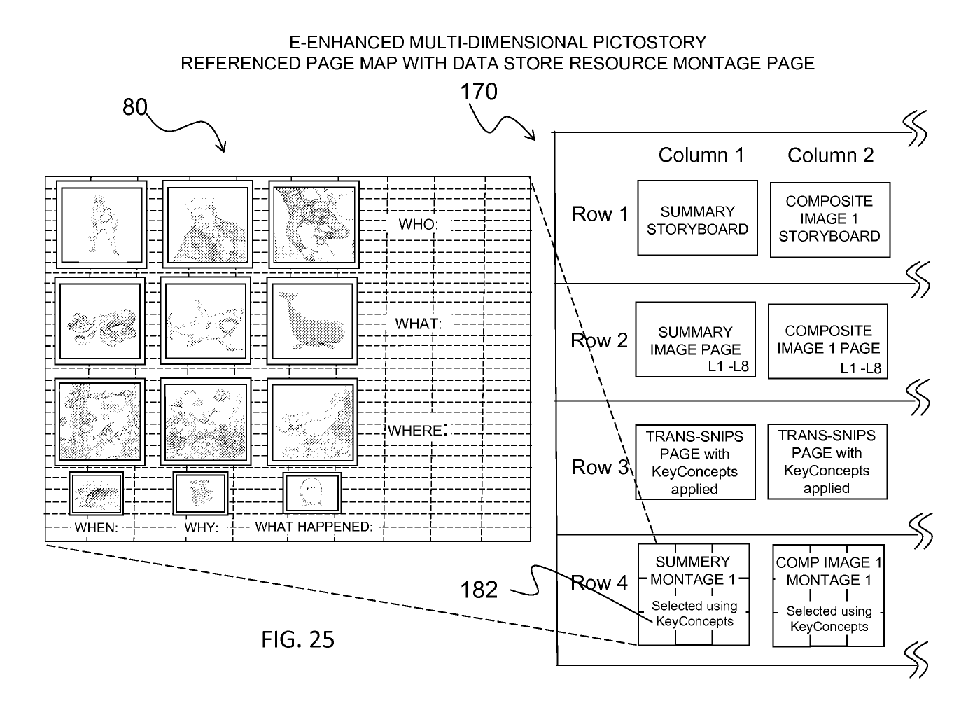

As shown in FIG. 23, by selecting the Summary Storyboard icon 176, the PictoStory Summary Storyboard opens and the controls to review, edit and present are available. Selecting the Summary Composite Image Page icon 178 or the Summary Trans-Snip Page icon 180, opens the Summary Composite Image Page 150 or Summary Trans-Snip Page 90 as shown in FIG. 24. By selecting the Montage Page icon as shown in FIG. 25, the Montage Page 80 opens. The Reference Page Map 170 also provides access to a Control Panel 148 that includes the Production Tools 27 for the PictoStory Blueprint 56. The Reference Page Map or PictoStory Wall 170 therefore provides access to every level, Component and Sub-Component of the E-Enhanced Multi-Dimensional PictoStory.

### Module B: PictoStory Blueprint—Control Panel

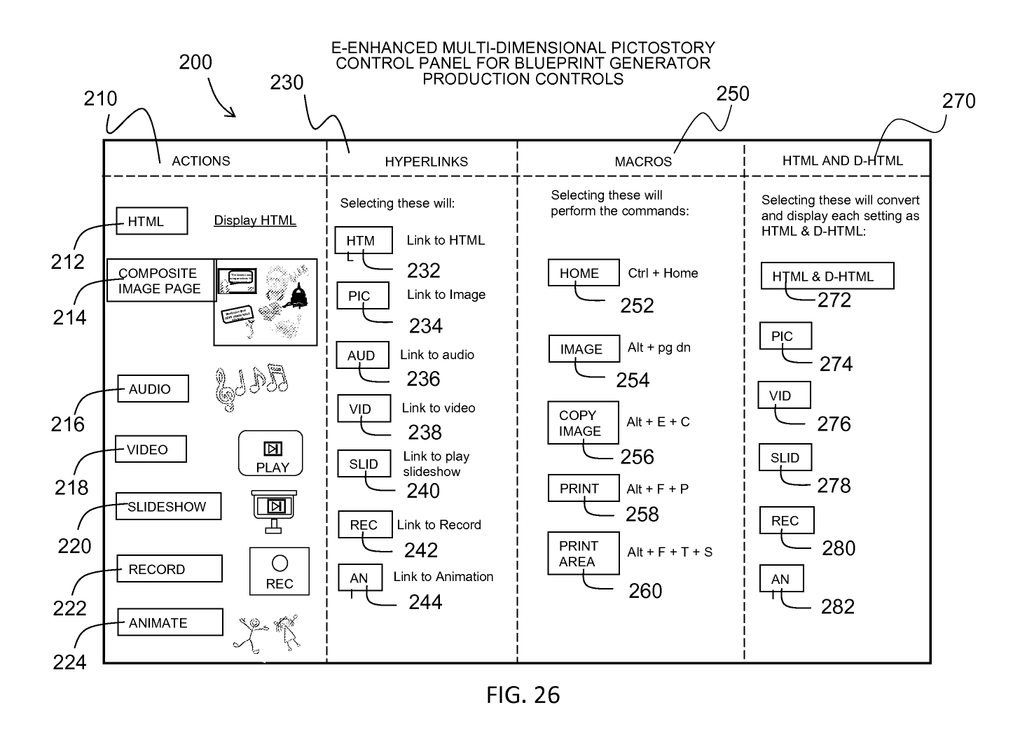

In a first embodiment, a Production Control Panel 200 within the PictoStory Blueprint 56 is shown in FIG. 26. The Production Control Panel 200 provides access to Actions 210, Hyperlinks 230, Macros 250, and conversions to HTML and Dynamic HTML (D-HTML) 270. Actions that may be performed to review, edit and modify the Pictorial Elements 21, Trans-Snips 58 and Enhancements 68 within the Composite Images 61 include displaying the HTML and Dynamic HTML Code 212 for the Composite Image, displaying the Composite Image Page 214 that is being edited, editing audio Enhancements 216 such as adding narration, editing video Enhancements 218, editing and ordering a slideshow 220, recording audio 222, such as music or narration for the Composite Image 61, or editing an animated enhancement 224.

A second control panel provides access to Hyperlinks 230 to link to page specific Dynamic HTML Code 232 to a Component or Sub-Component, to Images 234, to Audio 236, to Video 238, to Slideshows 240, to a Voice Recorder 242 and to Animation 244. A third control panel provides access to Macros 250 to go to the PictoStory Blueprint Page 252, to go to a specific Composite Image Page 256, to copy a Composite Image 258, to Print 260 a Composite Image 61 or to set a print area and print any Component or Sub-Component. A fourth control panel may provide access to display and edit Dynamic HTML Code 270 for the Components and Sub-Components 272, for Audio Enhancements 274, for Video Enhancements 276, for Slideshows 278, for Voice Recorder 280, and for Animation 282.

### Module B: Alternative E-Enhanced Multi-Dimensional PictoStory Presentations

Using the PictoStory Blueprint 56 and Production Control Tools 27, the Static Composite Images 61 formed from the structured Sequence of Elements 34 and pictorially representing the KeyConcepts 36 of the Basic Idea 12 are dynamically transformed with Enhancements 68 and production effects and are compiled to produce a film like E-Enhanced Multi-Dimensional PictoStory Presentation 72, This Set, Series or Sequence of Elements 34 may create a time or action sequence or a series of events that present a complete story or information about the Basic Idea 12. The Enhancements 68 may be interactive for a user presenting games and challenges that intrigue, captivate and entertain the User. A first PictoStory having for example five Sequence Elements 34 and Composite Images 61 representing the 6WCOOL KeyConcepts questions 36 may be combined with other PictoStory Storyboards to present complex, involved storylines, or technical information, or challenging games that increase in difficulty through different levels in complexity of each PictoStory.

A story having multiple characters may have multiple E-Composite Images for each character creating depth and personality using Trans-Snips 58 and Enhancements 68. The creation of a PictoStory by transforming a Basic Idea to an expanded Textual Outline 26 in a top down approach and developing Composite Images 61 from Raw Images 79 in a bottom up approach exemplifies the Multi-Dimensional formation of the PictoStory and using this form the Basic Idea may be further transformed by replacing one of the Multi-Dimension with alternative Components to change characters, settings, events, actions, and outcomes of the Basic Idea 12. a series of dimensions to extend, elaborate and transform the Basic Idea. By changing any of a Pictorial Element 21, a background Raw Image 79, or a character representing the Who of the KeyConcepts 36 or an Enhancement 68 will change the pictorial representation of the PictoStory. The Multi-Dimensional structure of the E-Enhanced Multi-Dimensional PictoStory Software provides a straight forward approach to immediately view Alternative Components 64 within the Multi-Dimensional PictoStory Presentation 72.

In selecting Alternative Components 64, the Data Store Resource 66 provides, Raw Images 79 and Pictorial Elements 21 that are broadly categorized and presented within one or more Montage Pages 80. The Alternative Components 64 are saved within file folders designated as Temporary or Variable Output. The active Components and Sub-Components are saved within file folders indicated as Output with each active Component saved with file names that correspond to locations on the Referenced Page Cell Map 124 of the PictoStory Blueprint 56. In selecting an Alternative Component 64 to replace an interchangeable Component or Sub-Component the file name for the Alternative Component 64 within the Variable Output Folder is changed to the same reference coordinate name as the interchangeable Component within the Output file Folder. Using the Production Controls of the Architectural or PictoStory Blueprint 56 allows for the Alternative Component 64 to be rendered and realized within the Variable Output Folder to be viewed within the film-like E-Enhanced Multi-Dimensional PictoStory Presentation. If the Alternative Component 64 selection is transferred from the Variable Output Folder to the final in use or active Output Folder it has the effect of completely transforming the PictoStory Presentation 72 with the E-Enhanced Multi-Dimensional Software Application 10 through the replacement of any Component or enhancement providing effortless, infinite variations of the same Basic Idea 12.

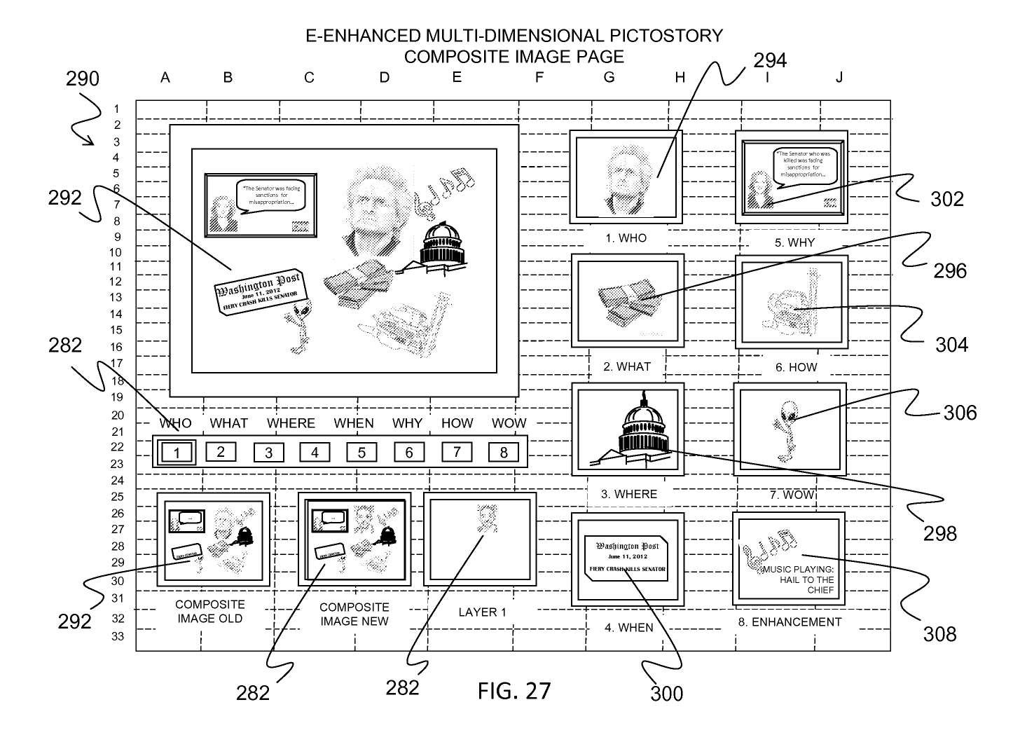

The Basic Idea 12 may include any information or idea to entertain, educate or inform. In a further example shown in FIG. 27, the Basic Idea 12 may present a complex story having many characters, settings, actions and outcomes that require multiple Composite Images 61 and PictoStory Storyboards 150. The Composite Image Page 290, shows a Composite Image 292 based on a structured Series of Elements 34 and the KeyConcepts Questions 36, the Basic Idea 12. The Composite Image 292 may include the President 294, a misappropriates of funds 296, a location of Washington D.C. 298, a newspaper headline 300 showing the date of the event, a reporter 302 investigating the story, an event may be a fiery car crash 304 that may be caused by an alien attack 306. Narration, video and audio Enhancements 308 dynamically accentuate the Basic Idea 12. The Composite Image 292 may be combined with other Composite Image StoryBoards to form a PictoStory that may be used to create a film-like E-Enhanced Multi-Dimensional PictoStory Presentation.

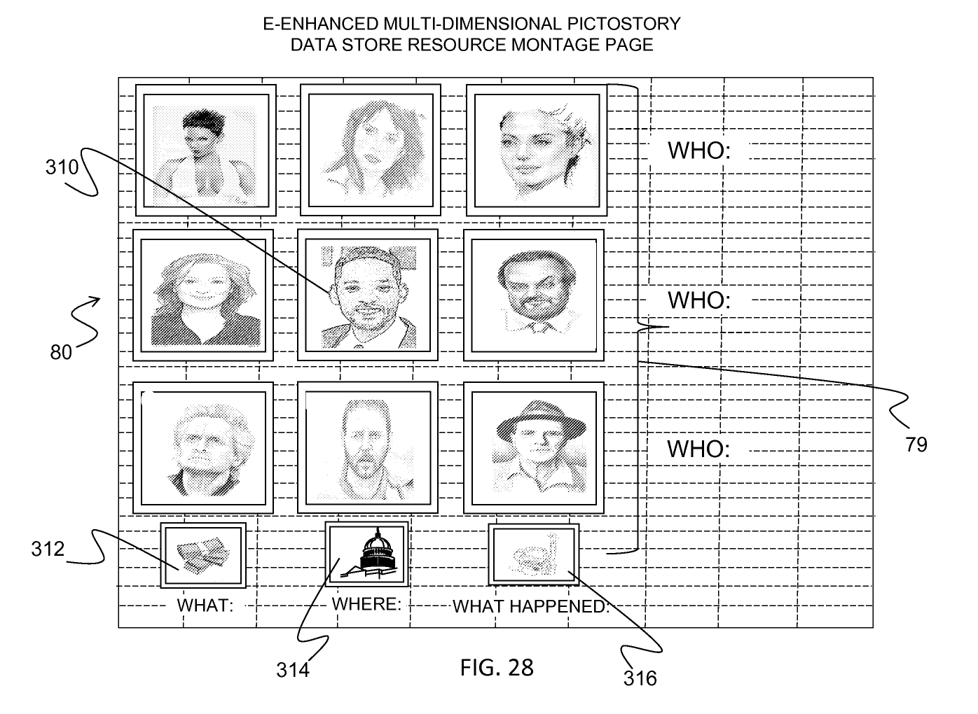

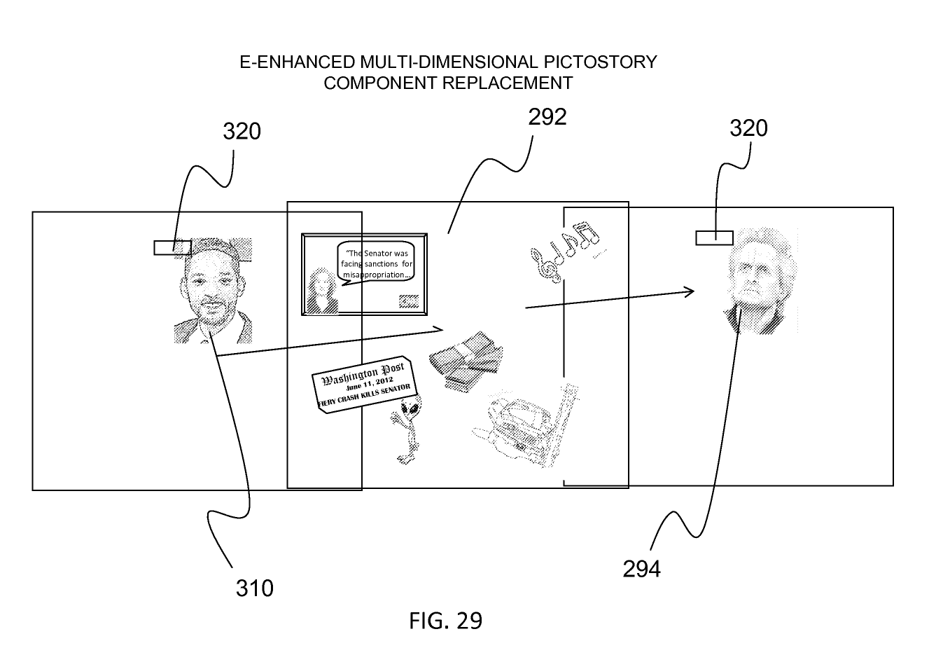

Using the Referenced Page Map 170 access to Montages 80 provide Alternative Components 64 that may be reviewed and selected to be placed in the Variable Output Folders within the Data Store Resource 66. The Raw Images 79 may be alternative poses for the character that may be alternatively selected to replace the KeyConcepts Who Component. Additional Raw Images 79 showing alternative characters that may be available to select and replace any character within the Composite Image 292. A shown in FIG. 28, nine separate Raw Images 79 provide alternatives for the replacement of the KeyConcepts Who, the President 294 and by selecting one of the Images 310 the Image 310 is moved to a Variable Output Folder for replacement in the E-Enhanced Multi-Dimensional PictoStory Presentation 72. Access to other categorized KeyConcepts Alternatives 64 such as What 312, Where 314, What Happened 316 are also provided within the Montage Page 80. As shown in FIG. 29, a first Trans-Snip layer 294 showing the Interchangeable President Character is replaced with a second Trans-Snip layer 310 that is given the same Reference Page Cell Map file name as the first Trans-Snip 294. When the Composite Image 292 is activated the President Character Trans-Snip layer 294 is replaced with the new President Character Trans-Snip layer 310 which because of the matched file naming structure based on the Referenced Page Cell Map 124 locates the Alternative President Character Component at the same position 320 within the layered Composite Image 290.

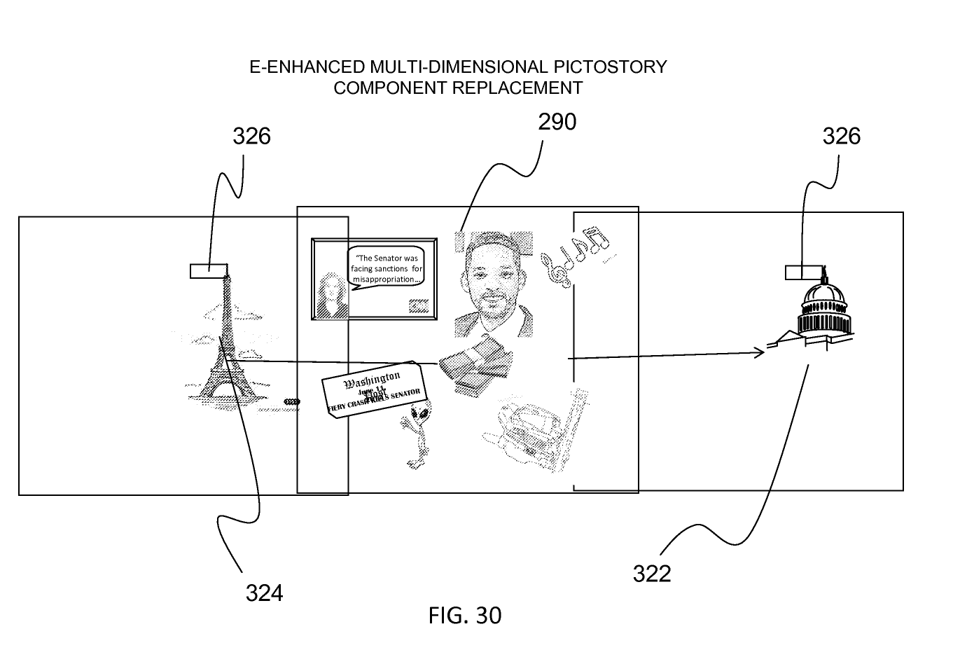

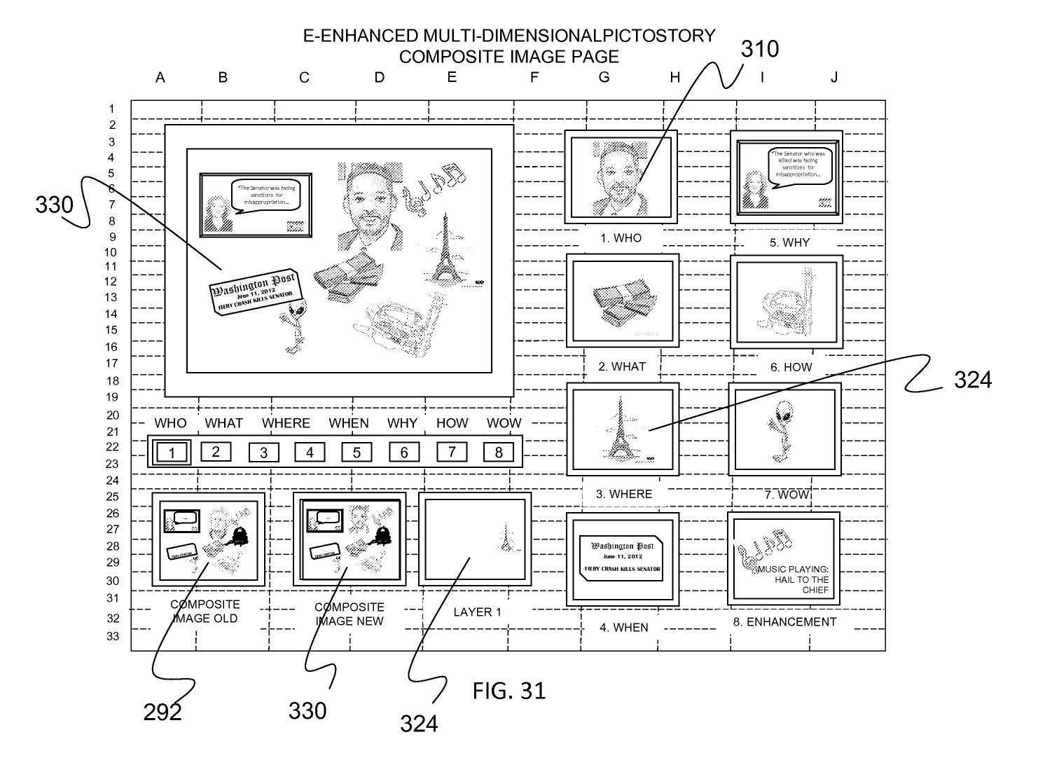

Similarly, the Alternative Component 64 may be the KeyConcepts 36 related to the Where, When or How such as a geographic location, the Time, the Weather, the Season or the Era, the Event Context or Action and Outcome. As shown in FIG. 30, by selecting from the series of geographical locations within a Montage Page 80 an Alternative Component may be selected to change the Composite Image 290 from a first Trans-Snip layer 322 representing Washington D.C. to a second Trans-Snip layer 324 representing Paris. The second Trans-Snip layer 324 is given the same file name based on the Referenced Page Cell Map location 326 as the Interchangeable first Trans-Snip layer 322. When the image is finally rendered as shown in FIG. 31, the Alternative Components 310 and 324 are moved from the temporary Variable Output Folder to the Output Folder within the Data Store Resource and the Who KeyConcepts for the Presidential Character 310 and the Where KeyConcepts for the location 324 are displayed within the Composite Image 290. Any Component or Sub-Component may be added to with Enhancements or changed within the controlled access environment the Architectural or PictoStory Blueprint.

### Details of Module C: The PictoStory Presenters

Structurally, it is important to note that each PictoStory Blueprint 56 provides for any Component or Sub-Component such as a Composite Image 61 or Trans-Snip Layer 58 to be viewed as a full screen rendering or within the active viewers 181, 231, or 233 at any time. The PictoStory Blueprint further provides access controls to limit modification and editing of the PictoStory at appropriate levels based on users and viewers of the E-Enhanced Multi-Dimensional PictoStory Presentation 72. The Production Controls 27 provide a conversion to HTML or enhanced Dynamic HTML to convert the Composite Images 61 within a PictoStory Storyboard 150 from a static to the dynamic state to actively view a finished or partly finished film-like Multi-Dimensional PictoStory Presentation. An important feature of the invention is the use of Dynamic HTML with any Page, Component layer, Component, or Sub-Component. Using Dynamic HTML, a timing and sequence dimension may be added to for example the layers of a Composite Image 61 to display each layer at different times to create movement or provide a sequence to the displayed events. Visual effects using D-HTML or other coded sub-routines may further be introduced to accentuate a layer by zooming, panning, changing colors or focus of a Trans-Snip 58 within an enhanced activated layer. For the Presentation 72, global visual effects dynamically link, order and sequence a group of Composite Images 61 to present the PictoStory with timing and structure to Show Not Tell a complete story.

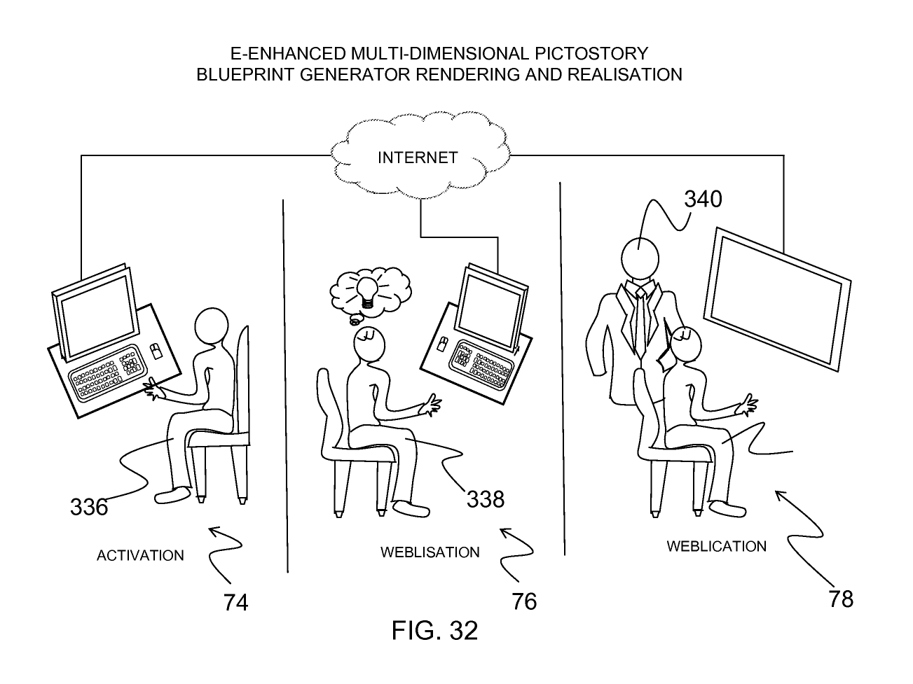

The level of access to control and modify a PictoStory, as shown in FIG. 32, is achieved through one of three methods described as Activation 330 through Rendering and Realization using HyperMacroHTML, WebliZation 332 using Dynamic HTML, and WebliCation 334 that provides viewing the E-Enhanced Multi-Dimensional PictoStory Presentation 72 within a secure website.

At the Activation level 74, Rendering and Realization is performed by a Developer 336 who using the E-Enhanced Multi-Dimensional PictoStory Software Application 10 may create and pictorially present, edit, modify, enhance, navigate, and transform the Basic Idea 12 and its Components and Sub-Components into an E-Enhanced Multi-Dimensional PictoStory Presentation 72. Upon draft or final completion, the Developer 336 renders any PictoStory Storyboard 150, Composite Image 61, or Enhancement 68 to provide restricted access for viewing all or any part of the pictorial representation or PictoStory of the Basic Idea. The activation is done within PictoStory Blueprint and is performed using a Hyperlink, macro or Dynamic HTML file from any reference point within the PictoStory Blueprint Referenced Cell Map 124.

At the WebliZation level 76 the Presentation 72 is provided in an Enhanced Dynamic HTML, proprietary, internal client-based format that allows a Producer 338 to view, partially edit, and select Alternative Components 64 such as for KeyConcepts or Enhancements 68. Final rendering for permanent replacement of Interchangeable Components is not provided at the WebliZation level, however viewing of presentations incorporating the Alternative Components 64 is and in this way a determination of Alternatives may be communicated to the Developer 334 for final rendering to implement the suggested changes by the Producer 338.

Access through WebliCation 78 allows a third party 340, an investor for example to view the final E-Enhanced Multi-Dimensional PictoStory Presentation 72 through a secure website. As an example the PictoStory Presentation 72 may be used by the Producer 336 to acquire financial backing for the Basic Idea 12 in order to record, film, or perform the Basic Idea 12 as a song, a musical, a video, a play, a video game, a full length movie, an educational Summary or in other presentation formats. The Developer 334 publishes the project through the secure website in a .COM format which in turn renders full functionality to all Enhancements and features of the PictoStory Presentation 72 for viewing or selecting and suggesting Alternative Components 64. With minimal initial investment using the E-Enhanced Multi-Dimensional PictoStory Software Application 10 a dynamic E-Enhanced Multi-Dimensional PictoStory Presentation is created to intrigue, entertain, educate, and have users interact with the Basic Idea 12.

### Details of the E-Enhanced Multi-Dimensional PictoStory Software Application

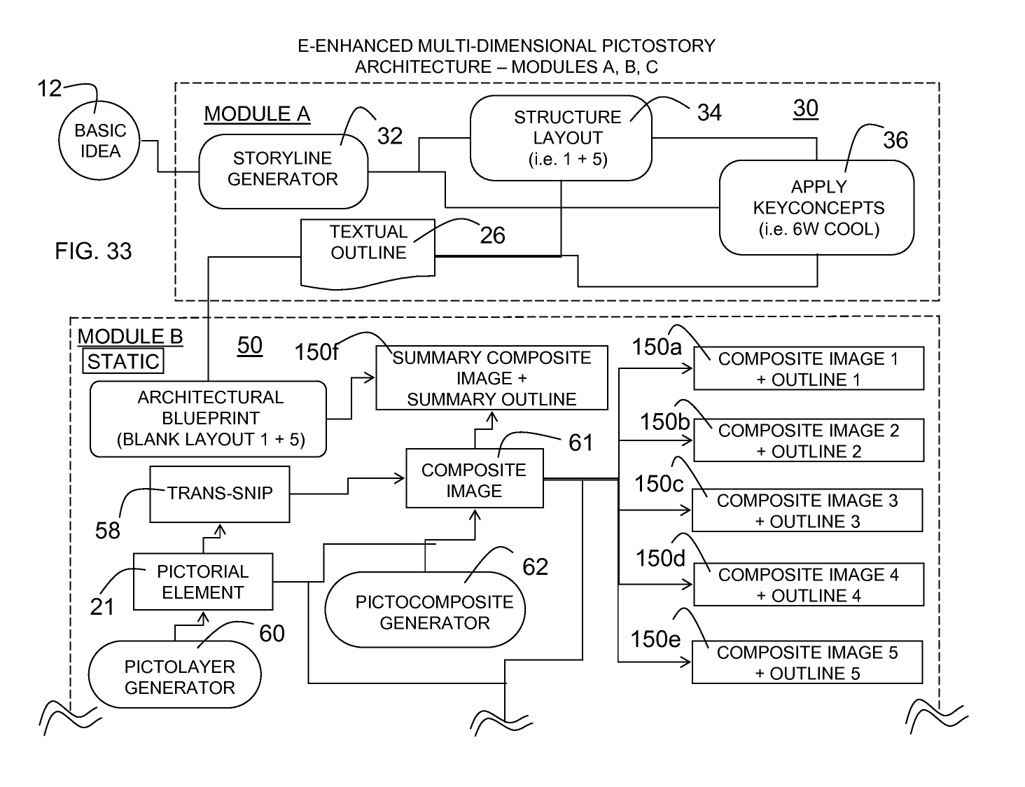

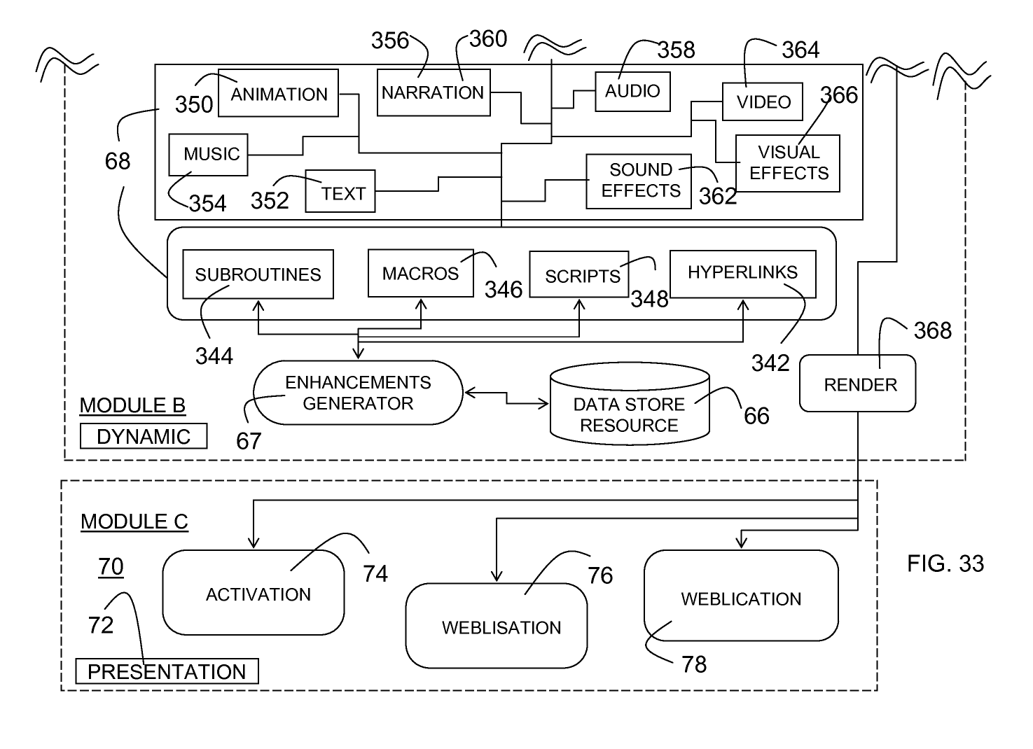

As shown in FIG. 33 a review of the components of the E-Enhanced Multi-Dimensional PictoStory Software Application 10 includes Modules A, B and C. In Module A, using a Storyline Generator 32, the Basic Idea is divided into a structured set, series or Sequence of Elements 34 and a KeyConcepts Query 36 is applied to each of the Set of Elements 34 that includes in this example Five Elements and a Summary 28. The Basic Idea 12 is then transformed using the responses to the KeyConcepts Query to a set of Textual Outlines 26a-26b and a Summary 26f. The KeyConcepts 36 may be in the form of a group of the 6WCool questions of Who?, What?, Where?, When?, Why?, How?, What happened?, Cool, that expand the Basic Idea 12.

In Module B 30, a Transparent Blank Architectural Blueprint 54 is populated with the Textual Outlines 26a-26f and using a PictoLayer Generator 60 a series of Trans-Snips 58 are created based upon responses to KeyConcepts Query 36. The Trans-Snips 58 are formed from Pictorial Elements 21 taken from a set of Raw Images 79. Using a PictoComposite Generator 62, the Trans-Snips 58 are layered to form Composite Images 61 that correspond in number to the Sequence of Elements 34 and the Summary 28. The Architectural Blueprint 54 is then populated with the Composite Images 61 forming PictoStory Storyboards 150a-150f. The Trans-Snips 58 and Composite Images 61 are then associated through hyperlinks 342, Sub-routines 344, macros 346, scripts 348 and other software applications to one or more Enhancements 68 using an Enhancements Generator 67. Enhancements 68 may be in any varied media formats, and may provide additional information about the KeyConcepts 36 of the Basic Idea 12, such as, Animation 350, Text 352, Music 354, Narration Text 356, Audio 358, Audio Narration 360, Sound Effects 362 and Video 364 and Visual Effects 366 and other any other supportive addition. Enhancements 68, as well as the Raw Images 79 used to create the Trans-Snips 58 and other files are categorized and stored within a Data Store Resource 66.

Using Control System Tools 27 within the Architectural Blueprint 32 in Module C, the static Composite Images 61 and dynamic Enhancements 68 are rendered 368 and realized to present the Basic Idea 12 as an informative, entertaining, engaging, film-like E-Enhanced Multi-Dimensional PictoStory Presentation 72 that includes access controls that restrict access to temporarily or permanently change the PictoStory content. The access is maintained in a first example at three levels, Activation 70, WebliZation 72 and WebliCation 74 as describe in further detail herein.

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

What is claimed is:

1. A pictorial representation software system for the creation of an enhanced multi-dimensional pictostory presentation, comprising:
application software installed on a computer system;
the application software further comprising;
a storyline generator;
a pictolayer generator;
a pictocomposite generator;
an enhancements generator;
a blueprint generator; and
wherein a textual data file is transformed into an expanded textual outline by the storyline generator;
a plurality of trans-snips representing the expanded textual outline are created by the pictolayer generator;
the plurality of trans-snips are layered to form at least one composite image by the pictocomposite generator;
the textual outlines, plurality of trans-snips and at least one composite image are located within an architectural blueprint formatted by the blueprint generator to form at least one pictostory;
at least one enhancement is associated to one of at least one trans-snip from the plurality of trans-snips, at least one composite image and at least one pictostory within the architectural blueprint using the enhancements generator; and
at least one pictostory is rendered to create an enhanced multi-dimensional pictostory presentation.

2. The pictorial representation software system for the creation of an enhanced multi-dimensional pictostory presentation of claim 1, wherein the storyline generator structures the textual data file into a plurality of elements and at least one summary and applies a query of key concepts in a responsive format to the plurality of elements and at least one summary to create the expanded textual outline.

3. The pictorial representation software system for the creation of an enhanced multi-dimensional pictostory presentation of claim 1, wherein at least one trans-snip from the plurality of trans-snips is formed from a raw image by shaping, cropping and sizing the raw image.

4. The pictorial representation software system for the creation of an enhanced multi-dimensional pictostory presentation of claim 3, wherein the raw image is stored within a data store resource.

5. The pictorial representation software system for the creation of an enhanced multi-dimensional pictostory presentation of claim 3, wherein at least one trans-snip from the plurality of trans-snips is formed from the raw image by removing a white background and locating the at least one trans-snip on a transparent blank.

6. The pictorial representation software system for the creation of an enhanced multi-dimensional pictostory presentation of claim 4, wherein the architectural blueprint further comprises a plurality of blank transparent sheets, each sheet having a page map coordinate system for locating at least one trans-snip from the plurality of trans-snips, at least one composite image and at least one enhancement.

7. The pictorial representation software system for the creation of an enhanced multi-dimensional pictostory presentation of claim 6, wherein the page map coordinate system of the architectural blueprint further structures at least one alternative trans-snip, at least one alternative composite image, and at least one alternative enhancement within the data store resource for replacement within the enhanced multi-dimensional pictostory presentation.

8. The pictorial representation software system for the creation of an enhanced multi-dimensional pictostory presentation of claim 1, wherein the at least one composite image further comprises a cell map coordinate system and at least one enhancement is associated with a location on the cell map.

9. The pictorial representation software system for the creation of an enhanced multi-dimensional pictostory presentation of claim 1, wherein at least one trans-snip from the plurality of trans-snips further comprises a resolution map coordinate system and at least one enhancement is associated with a location on the resolution map.

10. The pictorial representation software system for the creation of an enhanced multi-dimensional pictostory presentation of claim 1, wherein at least one enhancement is at least one of audio files, recorded narration, animation, video files, video effects, sound effects, slide shows, and image components.

11. The pictorial representation software system for the creation of an enhanced multi-dimensional pictostory presentation of claim 1, wherein access to the pictorial representation software system and the enhanced multi-dimensional pictostory presentation is restricted.

12. A method of representing a textual data file of a basic idea pictorially, comprising the steps of:
accessing application software installed on a computer system;
entering a textual data file of a basic idea into the application software;
transforming the textual data file of the basic idea into an expanded textual outline;
creating a plurality of trans-snips related to the expanded textual outline;
layering the plurality of trans-snips to form at least one composite image;
populating a pictostory blueprint with the textual outlines, the plurality of trans-snips and the at least one composite image to create at least one pictostory;
associating at least one enhancement with one of at least one trans-snip from the plurality of trans-snips, at least one composite image and at least one pictostory;
rendering at least one of the plurality of trans-snips, at least one composite image, at least one pictostory and at least one enhancement to create a pictorial presentation of the basic idea.

13. The method of representing a textual data file of a basic idea pictorially of claim 12, further comprising the steps of structuring the textual data file of the basic idea into a plurality of elements and at least one summary and applying key concepts to the plurality of elements and at least one summary.

14. The method of representing a textual data file of a basic idea pictorially of claim 12, further comprising the step of forming a transparent blank within the pictostory blueprint having a page map coordinate system for locating at least one trans-snip from the plurality of trans-snips, at least one composite image, at least one pictostory and at least one enhancement within the page map.

15. The method of representing a textual data file of a basic idea pictorially of claim 12, further comprising the step of replacing one of at least one trans-snip from the plurality of trans-snips, at least one composite image and at least one enhancement with one of at least an alternative trans-snip, an alternative composite image and an alternative enhancement.

16. The method of representing a textual data file of a basic idea pictorially of claim 12, further comprising the step of associating a cell map coordinate system with at least one composite image and associating at least one enhancement with a location on the cell map.

17. The method of representing a textual data file of a basic idea pictorially of claim 12, further comprising the steps of associating a resolution map coordinate system with at least one trans-snip from the plurality of trans-snips and associating at least one enhancement with a location on the resolution map.

18. The method of representing a textual data file of a basic idea pictorially of claim 12, further comprising the steps of creating at least one trans-snip from the plurality of trans-snips from a raw image retrieved from a data store resource by shaping, cropping and sizing the raw image.

19. The method of representing a textual data file of a basic idea pictorially of claim 18, further comprising the steps of creating at least one trans-snip from the plurality of trans-snips by removing a white background and locating the at least one trans-snip from the plurality of trans-snips on a transparent blank.

20. The method of representing a textual data file of a basic idea pictorially of claim 12, further comprising the step of selecting at least one enhancement from at least one of audio files, recorded narration, animation, video files, video effects, sound effects, slide shows, and image components.
